(19) United States
(12) Patent Application Publication
(10) Pub. No.: US 2012/0249565 A1
(43) Pub. Date: Oct. 4, 2012

(54) SIGNAL PROCESSING CIRCUIT, SIGNAL PROCESSING METHOD, AND DISPLAY APPARATUS

(76) Inventors: Mikio ISHII, Kanagawa (JP); Masahiro Take, Kanagawa (JP); Shoji Kosuge, Kanagawa (JP)

(21) Appl. No.: 13/428,129

(22) Filed: Mar. 23, 2012

(30) Foreign Application Priority Data
Mar. 30, 2011 (JP) 2011-074348

(51) Int. Cl. G09G 5/39

(52) U.S. Cl. 345/531

(57) ABSTRACT

A signal processing circuit includes: a memory storing an image signal; a write control unit generating a write control signal in synchronization with the input image signal and frame identification information, and storing the input image signal in the memory so that the input image signal corresponds to the frame identification information on the basis of the write control signal; and a read control unit generating a read control signal through obtaining a vertical synchronization signal supplied from outside based on a timing signal of an output horizontal frequency, and reading an image signal that corresponds to the frame identification information from the memory on the basis of the read control signal and the frame identification information supplied from outside.

### FIELD

The present disclosure relates to a signal processing circuit, a signal processing method, and a display apparatus. More particularly, the present disclosure relates to a signal processing circuit, a signal processing method, and a display apparatus, which enables low delay and reduction in circuit size when performing high-resolution image display in a multi-chip configuration using a plurality of signal processing circuits.

### BACKGROUND

In the related art, high-resolution image display is performed using a tiling process. For example, according to JP-A-2001-195053, a screen of which the display area is virtually divided into a plurality of sub-screens, and a graphic adapter is provided for each sub-screen. The graphic adapter has two frame buffers. The graphic adapter writes an image signal in one buffer while reading an image signal that is stored in the other buffer, and writes an image signal of the next frame with respect to the buffer from which reading of the image signal has been completed.

FIG. 1 exemplifies the configuration of a display apparatus in the related art that performs high-resolution image display with a multi-chip configuration using a plurality of signal processing circuits. A display apparatus 50 includes signal processing circuits 60-A to 60-D, frame buffers 70-A to 70-D, timing control circuits (T-Con) 75-A to 75-D, a frame buffer control unit 80, and oscillators 85-A to 85-D.

An image signal IW_Data, a clock signal IW_CLK that corresponds to the image signal IW_Data, a horizontal synchronization signal IW_H, a vertical synchronization signal IW_V, and a frame signal IW_FLD are supplied to the signal processing circuit 60-A. Further, the frame signal is used to identify a first frame and a second frame in the case of performing native display based on an interlace signal or to identify an image signal of each viewpoint in performing 3D display using, for example, a left viewpoint image signal and a right viewpoint image signal. The signal processing circuit 60-A performs signal processing of the image signal that corresponds to the display area.

Further, in the same manner as the signal processing circuit 60-A, the image signal, the horizontal synchronization signal, the vertical synchronization signal, and the frame signal are supplied to the signal processing circuits 60-B to 60-D, and the signal processing of the image signals that correspond to the respective display areas is performed. For example, one screen is divided into four display areas on the upper, lower, left, and right sides, and the signal processing circuit 60-A performs signal processing of the image signal that corresponds to, for example, the upper left display area. In the same manner, the signal processing circuit 60-B performs signal processing of the image signal that corresponds to, for example, the upper right display area, the signal processing circuit 60-C performs signal processing of the image signal that corresponds to, for example, the lower left display area, and the signal processing circuit 60-D performs signal processing of the image signal that corresponds to, for example, the lower right display area.

The image signal processed by the signal processing circuit 60-A is stored in the frame buffer 70-A. Further, the image signals processed by the signal processing circuits 60-B to 60-D are stored in the frame buffers 70-B to 70-D, respectively.

The image signals stored in the frame buffers 70-A to 70-D are synchronously read and supplied to the timing control circuits 75-A to 75-D. The timing control circuit 75-A receives the image signal read from the frame buffer 70-A, and outputs the received signal to a driver (not illustrated) of a display device in a predetermined format and as a timing signal. In the same manner, the timing control circuits 75-B to 75-D receive the image signals read from the frame buffers 70-B to 70-D, and output the received signals to drivers (not illustrated) of the display device in a predetermined format and as timing signals, respectively.

The frame buffer control unit 80 controls the operation of the respective frame buffers 70-A to 70-D. The frame buffer control unit 80 generates a write signal WCT based on a synchronization signal or a frame signal supplied from the signal processing circuit 60-A. The frame buffer control unit 80 supplies the generated write signal WCT to the frame buffer 70-A to store the image signal output from the signal processing circuit 60-A. In the same manner, the frame buffer control unit 80 generates a write signal on the basis of the synchronization signal or the frame signal supplied from the signal processing circuits 60-B to 60-D. The frame buffer control unit 80 supplies the generated write signal to the frame buffers 70-B to 70-D to store the image signals output from the signal processing circuits 60-B to 60-D. Further, the frame buffer control unit 80 generates and supplies a read signal RCT to the respective frame buffers 70-A to 70-D, and synchronously reads and outputs the stored image signals to the timing control circuits 75-A to 75-D.

The oscillator 85-A generates a system clock signal that is a reference frequency signal for operating the signal processing circuit 60-A. In the same manner, the oscillators 85-B to 85-D generate system clock signals that are reference frequency signals for operating the signal processing circuits 60-B to 60-D.

### SUMMARY

Here, in the case of performing high-resolution image display in a multi-chip configuration, not only one screen display is performed as a whole, but also an input signal of an independent frame frequency is needed to be displayed for each signal processing circuit. Because of this, the frame buffers 70-A to 70-D may have large capacity. For example, it is assumed that the frame frequency of the image signal that is input to the signal processing circuit is 48 Hz, and the frame frequency of the image signal that is output from the frame buffer is 60 Hz. In this case, each of the frame memories 70-A to 70-D has a memory capacity of two frames, and an image signal is written in a memory area of one frame while an image signal that is stored in a memory area of the other frame is read. As described above, through making the frame buffers have a large capacity, it becomes possible to display an input signal of independent frame frequency. However, since large-capacity frame buffers are used, it is difficult to lower the cost or to provide a smaller circuit.

Thus, it is desirable to provide a signal processing circuit, a signal processing method, and a display apparatus, which can perform high-resolution image display without using frame buffers.

An embodiment of the present disclosure is directed to a signal processing circuit which includes a memory storing an image signal; a write control unit generating a write control signal in synchronization with the input image signal and frame identification information, and storing the input image signal in the memory so that the input image signal corresponds to the frame identification information on the basis of the write control signal; and a read control unit generating a read control signal through obtaining a vertical synchronization signal supplied from outside based on a timing signal of an output horizontal frequency, and reading an image signal that corresponds to the frame identification information from the memory on the basis of the read control signal and the frame identification information supplied from outside.

In the signal processing circuit according to the embodiment of the present disclosure, the image signal that is used for signal processing is stored in the memory. The write control unit generates the write control signal in synchronization with the input image signal and the frame identification information, and stores the input image signal in the memory so that the input image signal corresponds to the frame identification information on the basis of the write control signal. Further, in the case of performing image display simultaneously using a plurality of signal processing circuits, the read control unit generates the read control signal through obtaining the vertical synchronization signal supplied from outside based on the timing signal of the output horizontal frequency. In generating the read control signal, the read control unit detects a phase difference between a vertical synchronization signal generated on the basis of the timing signal of the output horizontal frequency and the vertical synchronization signal supplied from outside and a phase difference between the timing signal of the output horizontal frequency and a horizontal synchronization signal supplied from outside, adjusts phases of the timing signal of the output horizontal frequency and the vertical synchronization signal that is generated on the basis of the timing signal so that the phase differences are less than a predetermined value, and generates the read control signal using the signal after the adjustment. The read control unit reads the image signal that corresponds to the frame identification information from the memory on the basis of the generated read control signal and the frame identification information supplied from outside.

A skew compensation unit may be installed to delay a synchronization signal supplied from outside so that the image signal that corresponds to the frame identification information can be read from the memory on the basis of the read control signal and the frame identification information even if the input image signal and an input image signal input to another signal processing circuit produce skews.

A display stop control unit may be installed, and if a display stop instruction signal is supplied, obtaining the display stop instruction signal is performed in the unit of a frame or in the unit of multiple frames on the basis of an input latch signal, and the obtained display stop instruction signal is output to the write control unit and the read control unit. The write control unit stops storing the input image signal in the memory during a display stop period on the basis of the display stop instruction signal. Further, the read control unit repeatedly reads the image signal read before the display stop during the display stop period on the basis of the display stop instruction signal. Further, the image signal that corresponds to the frame identification information is read from the memory on the basis of the frame identification information supplied from outside, and the read image signal is supplied to, for example, an external device to capture a still image. Further, a replacement image signal is stored in the memory to correspond to the frame identification information on the basis of the frame identification information supplied from outside. Thereafter, through reading the replacement image signal that is stored in the memory to correspond to the frame identification information on the basis of the frame identification information supplied from outside, the still image can be easily replaced by a still image supplied from the external device even in the multi-chip configuration.

Another embodiment of the present disclosure is directed to a signal processing method which includes generating a write control signal in synchronization with an input image signal and frame identification information, and storing the input image signal in the memory so that the input image signal corresponds to the frame identification information on the basis of the write control signal; and generating a read control signal through obtaining a vertical synchronization signal supplied from outside based on a timing signal of an output horizontal frequency, and reading an image signal that corresponds to the frame, identification information from the memory on the basis of the read control signal and the frame identification information supplied from outside.

Still another embodiment of the present disclosure is directed to a display apparatus including signal processing circuits for a plurality of display areas that constitute one screen, which process image signals for the corresponding display areas, respectively, wherein each of the signal processing circuits includes a memory storing an image signal; a write control unit generating a write control signal in synchronization with the input image signal and frame identification information, and stores the input image signal in the memory so that the input image signal corresponds to the frame identification information on the basis of the write control signal; and a read control unit which generates a read control signal through obtaining a vertical synchronization signal supplied from outside commonly to the respective signal processing circuits based on a timing signal of an output horizontal frequency, and reading an image signal that corresponds to the frame identification information from the memory on the basis of the read control signal and the frame identification information supplied from outside commonly to the respective signal processing circuits.

In the display apparatus according to the embodiment of the present disclosure, the signal processing circuits are provided for the plurality of display areas that constitute one screen, and each of the respective signal processing circuits processes the image signal on the corresponding display area. In each of the respective signal processing circuits, the image signal that is used for signal processing is stored in the memory. The write control unit of each signal processing circuit generates the write control signal in synchronization with the input image signal and the frame identification information, and stores the input image signal in the memory so that the input image signal corresponds to the frame identification information on the basis of the write control signal. Further, in the case of performing image display simultaneously using the respective signal processing circuits, the write control unit of each signal processing circuit generates the read control signal through obtaining the vertical synchronization signal supplied from outside commonly to the respective signal processing circuits based on the timing signal of the output horizontal frequency. In generating the read control signal, the read control unit generates the read control signal through obtaining the vertical synchronization signal supplied from outside based on the timing signal of the output horizontal frequency. The read control unit reads the image signal that corresponds to the frame identification information from the memory on the basis of the read control signal and the frame identification information supplied from outside commonly to the respective signal processing circuits.

A skew compensation unit may be installed to delay a synchronization signal supplied from outside so that the image signal that corresponds to the frame identification information can be read from the memory on the basis of the read control signal and the frame identification information even if the input image signal and an input image signal input to another signal processing circuit produce skews.

A system clock signal generated by one oscillation unit may be supplied to the respective signal processing circuits, and the read control unit of each signal processing circuit detects a phase difference between a vertical synchronization signal generated on the basis of the timing signal of the output horizontal frequency and the vertical synchronization signal supplied from outside and a phase difference between the timing signal of the output horizontal frequency and a horizontal synchronization signal supplied from outside, adjusts phases of the timing signal of the output horizontal frequency and the vertical synchronization signal that is generated on the basis of the timing signal so that the phase differences are less than a predetermined value, and generates the read control signal using the signal after the adjustment.

A display stop control unit may be installed, and if a display stop instruction signal is supplied, obtaining the display stop instruction signal is performed in the unit of a frame or in the unit of multiple frames on the basis of an input latch signal, and the obtained display stop instruction signal is output to the write control unit and the read control unit. The write control unit stops storing the input image signal in the memory during a display stop period on the basis of the display stop instruction signal. Further, the read control unit repeatedly reads the image signal read before the display stop during the display stop period on the basis of the display stop instruction signal.

According to the embodiments of the present disclosure, the write control signal that is in synchronization with the input image signal and the frame identification information are generated, and the input image signal is stored in the memory so that it corresponds to the frame identification information on the basis of the write control signal. Further, the read control signal is generated through obtaining the vertical synchronization signal supplied from outside based on the timing signal of the output horizontal frequency, and the image signal that corresponds to the frame identification information is read from the memory on the basis of the read control signal and the frame identification information supplied from outside. Accordingly, in the case of supplying the synchronization signal supplied from outside to the plurality of signal processing circuits, the phase difference between the image signals output from the signal processing circuit becomes smaller. Through this, it is possible to make the phases of the image signals output from the signal processing circuits coincide with each other using line buffers, and thus high-resolution image display can be performed with low delay, reduction in circuit size, low power consumption, and a small outlay.

### BRIEF DESCRIPTION OF THE DRAWINGS

FIG. 1 is a diagram exemplifying the configuration of a display apparatus in the related art;

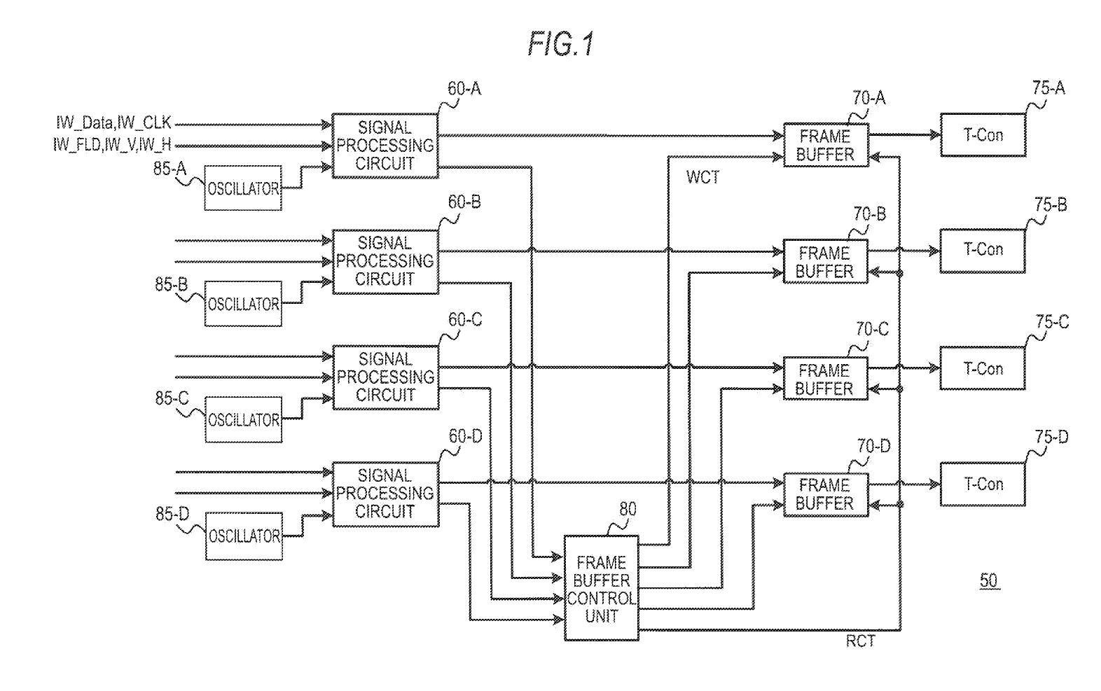

FIG. 2 is a diagram illustrating the configuration of a first embodiment;

FIG. 3 is a diagram illustrating the configuration of a signal processing circuit;

FIGS. 4A to 4K are timing diagrams illustrating the operation of signal processing circuits;

FIGS. 5A to 5C are diagrams illustrating display modes;

FIGS. 6A to 6E are timing diagrams illustrating the operation in a first display mode;

FIGS. 7A to 7F are timing diagrams illustrating the operation in a second display mode;

FIG. 8 is a diagram illustrating the configuration of a second embodiment;

FIG. 9 is a diagram illustrating the configuration of a signal processing unit having a display stop function;

FIGS. 10A to 10E are timing diagrams illustrating the operation of a signal processing unit having a display stop function;

FIG. 11 is a diagram illustrating display stop control units of four signal processing circuits;

FIGS. 12A to 12D are timing diagrams illustrating the operation of four signal processing circuits;

FIGS. 13A to 13E are timing diagrams illustrating the operation in the case where a field (frame) sequential type image signal is input to a signal processing circuit;

FIGS. 14A to 14D are timing diagrams in the case of obtaining a still image; and

FIGS. 15A to 15D are timing diagrams in the case of replacing a still image.

### DETAILED DESCRIPTION

Hereinafter, embodiments of the present disclosure will be described. The explanation thereof will be made in the following order.

1. First embodiment

1-1. Configuration of first embodiment

1-2. Operation of first embodiment

2. Second embodiment

2-1. Configuration of second embodiment

2-2. Operation of second embodiment

3. Third embodiment

3-1. Configuration of third embodiment

3-2. Operation of third embodiment

### 1. First Embodiment

### 1-1. Configuration of First Embodiment

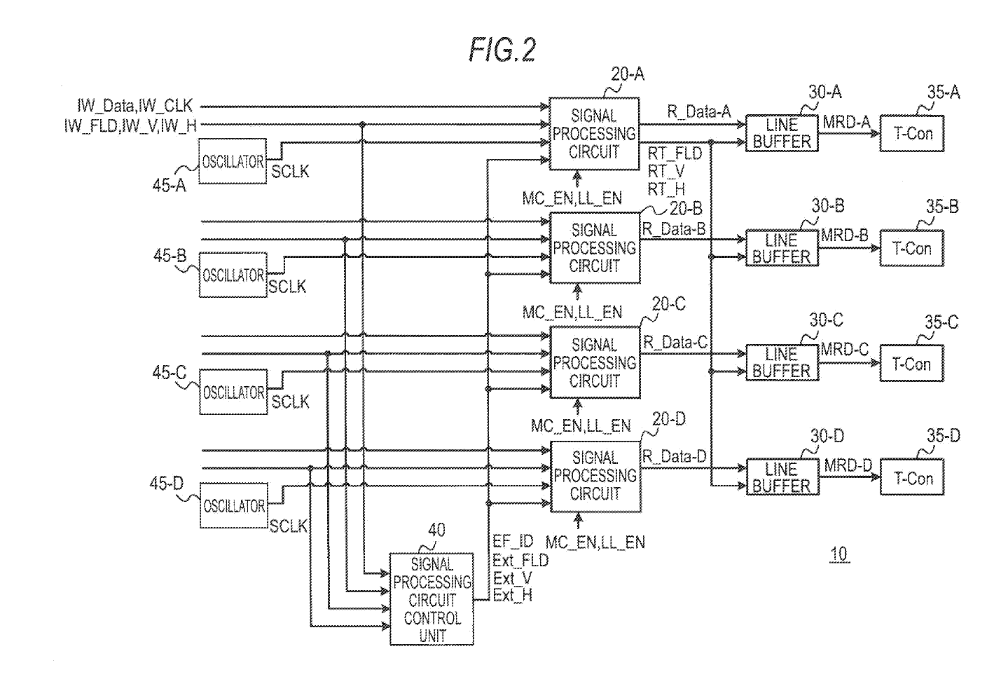

FIG. 2 is a diagram illustrating the configuration of a first embodiment. A display apparatus 10 includes signal processing circuits 20-A to 20-D, line buffers 30-A to 30-D, timing control circuits 35-A to 35-D, a signal processing circuit control unit 40, and oscillators 45-A to 45-D.

The signal processing circuits 20-A to 20-D process image signals that correspond to respective display areas. For example, one screen is divided into four display areas on the upper, lower, left, and right sides, and the signal processing circuit 20-A processes the image signal that corresponds to, for example, the upper left display area. In the same manner, the signal processing circuit 20-B processes the image signal that corresponds to, for example, the upper right display area, the signal processing circuit 20-C processes the image signal that corresponds to, for example, the lower left display area, and the signal processing circuit 20-D processes the image signal that corresponds to, for example, the lower right display area.

An image signal IW_Data, a clock signal IW_CLK that corresponds to the image signal IW_Data, a horizontal synchronization signal IW_H, a vertical synchronization signal IW_V, and a frame signal IW_FLD are supplied to the signal processing circuit 20-A. Further, a horizontal synchronization signal EXt_H, a vertical synchronization signal Ext_V, a frame signal Ext_FLD, and a frame identification signal EF_ID are supplied from the signal processing circuit control unit 40 to be described later to the signal processing circuit 20-A. Further, a chip configuration control signal MC_EN that indicates whether an operation that corresponds to a multi-chip configuration or a single-chip configuration is performed is supplied from a system control unit (not illustrated) to the signal processing circuit 20-A. The signal processing circuit 20-A processes an image signal that corresponds to the display area through capturing the image signal IW_Data on the basis of the clock signal IW_CLK, the horizontal synchronization signal IW_H, the vertical synchronization signal. IW_V, and the frame signal IW_FLD. In the case of performing an operation that corresponds to the multi-chip configuration on the basis of the chip configuration control signal MC_EN, the signal processing circuit 20-A outputs an image signal R_Data-A after the signal processing to the line buffer 30-A on the basis of the horizontal synchronization signal Ext_H, the vertical synchronization signal Ext_V, and the frame signal Ext_FLD.

In the same manner as the signal processing circuit 20-A, the signal processing circuits 20-B to 20-D process image signals that correspond to the respective display areas and output image signals R_Data-B to R_Data-D after the signal processing to the line buffers 30-B to 30-D. Further, in the case of performing an operation that corresponds to the single-chip configuration according to the chip configuration control signal MC_EN, the signal processing circuits 20-A to 20-D read the image signals on the basis of the horizontal synchronization signal IW_H, the vertical synchronization signal IW_V, and the frame signal IW_FLD.

The image signals stored in the line buffers 30-A to 30-D, for example, are synchronously read on the basis of a horizontal read timing signal RT_H, a vertical read timing signal RT_V, and a frame signal RT_FLD output from the signal processing circuit 20-A, and are supplied to the timing control circuits 35-A to 35-D.

The timing control circuit 35-A receives the image signal read from the line buffer 30-A, and outputs the received image signal to a driver (not illustrated) of a display device in a predetermined format and as a timing signal. In the same manner, the timing control circuits 35-B to 35-D receive the image signals read from the ling buffers 30-B to 30-D, and output the received signals to the driver (not illustrated) of the display device in a predetermined format and as timing signals.

In the case of using a signal processing circuit with a multi-Chip configuration, the signal processing circuit control unit 40 generates and supplies the horizontal synchronization signal Ext_H, the vertical synchronization signal Ext_V, the frame signal Ext_FLD, and the frame identification signal EF_ID to the signal processing circuits 20-A to 20-D.

The oscillator 45-A generates a system clock signal SCLK that is a reference frequency signal for operating the signal processing circuit 20-A. In the same manner, the oscillators 45-B to 45-D generate system clock signals SCLK for operating the signal processing circuits 20-B to 20-D. Further, the system clock signals SCLK generated by the oscillators 45-A to 45-D have the same frequency.

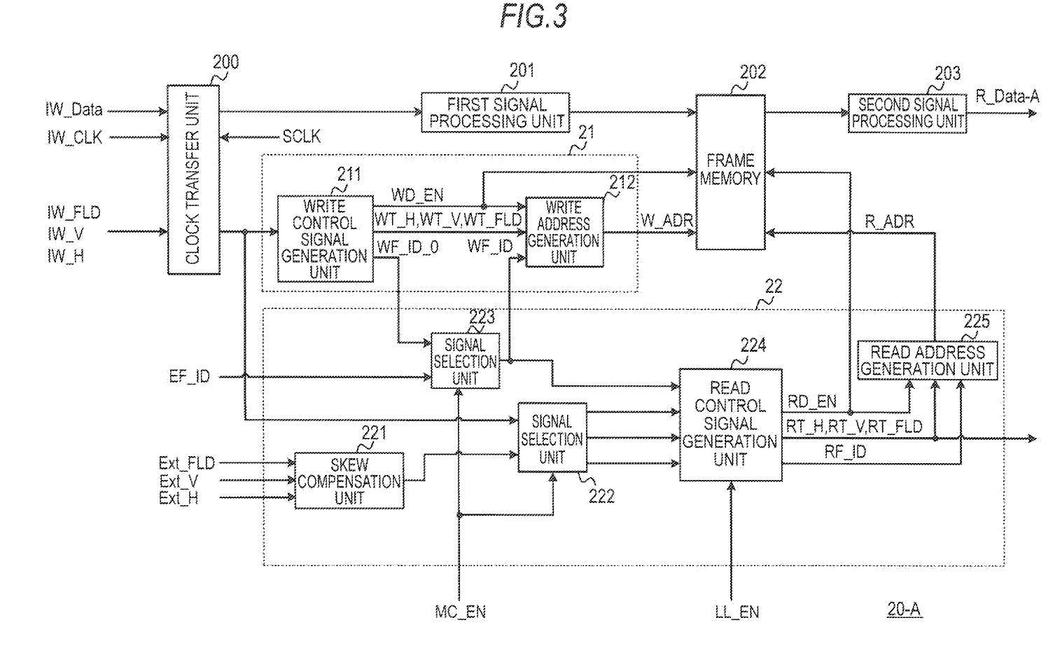

FIG. 3 exemplifies the configuration of a signal processing circuit. Since the signal processing circuits 20-A to 20-D are considered to have the same configuration, explanation will hereinafter be made only with respect to the signal processing circuit 20-A.

The image signal IW_Data is supplied to a clock transfer unit 200. The clock transfer unit 200 performs transfer of the clock signal, and makes the image signal IW_Data, the horizontal synchronization signal IW_H, the vertical synchronization signal IW_V, and the frame signal IW_FLD be in synchronization with the system clock signal SCLK from the clock signal IW_CLK. The clock transfer unit 200 outputs the image signal IW_Data after the clock transfer to a first signal processing unit 201. Further, the clock transfer unit 200 outputs the horizontal synchronization signal IW_H, the vertical synchronization signal IW_V, and the frame signal IW_FLD after the clock transfer to a write control signal generation unit 211 of a write control unit 21 and a signal selection unit 222 of a read control unit 22.

The first signal processing unit 201 performs various processes that do not use a memory, for example, luminance correction and color correction processes, with respect to the image signal IW_Data according to an instruction from a system control unit, and supplies the image signal after the processing to a frame memory 202. The frame memory 202 is to store image signals which are used for signal processing that generates a new image signal using image signals used for signal processing, for example, the stored image signal. The frame memory 202 is connected to a second signal processing unit 203. The second signal processing unit 203 performs various signal processes, for example, interlace/progressive conversion, size conversion, and double speed conversion processes using the image signal stored in the frame memory 202 according to the instruction from the system control unit, and generates a new image signal.

The write control signal generation unit 211 of the write control unit 21 generates a horizontal write timing signal WT_H and a vertical write timing signal WT_V on the basis of the horizontal synchronization signal IW_H, the vertical synchronization signal IW_V, and the frame signal IW_FLD. The write control signal generation unit 211 supplies the generated signals to a write address generation unit 212 together with the frame signal WT_FLD that is synchronized with the signals. Further, the write control signal generation unit 211 generates and supplies a write enable signal WD_EN to the frame memory 202 and the write address generation unit 212. Further, the write control signal generation unit 211 generates a write frame identification signal WF_ID_0 in a self-running manner on the basis of the frame signal IW_FLD, and supplies the write frame identification signal WF_ID_0 to the signal selection unit 223.

In the case where the write permission is performed by the write enable signal WD_EN, the write address generation unit 212 generates a write address signal W_ADR on the basis of the horizontal write timing signal WT_H, the vertical write timing signal WT_V, the frame signal WT_FLD, and the frame identification signal WF_ID supplied from the signal selection unit 223. The write address generation unit 212 supplies the generated write address signal W_ADR to the frame memory 202, and stores the image signal output from the first signal processing unit 201 in the frame memory 202.

In the case of performing image display in a multi-chip configuration using a plurality of signal processing circuits, a skew compensation unit 221 of the read control unit 22 prevents malfunction due to a skew which may be produced in input image signals between the respective signal processing circuits. The skew compensation unit 221 adjusts the timing so that the image signals after the signal processing can be output from the respective signal processing circuits with the phase difference reduced, on the basis of the horizontal synchronization signal Ext_H, the vertical synchronization signal Ext_V, and the frame signal Ext_FLD which are supplied from the signal processing circuit control unit 40. The skew compensation unit 221 outputs the respective signals after the timing adjustment to the signal selection unit 222. For example, if a skew that corresponds to maximum four clocks of the system clock is produced between the respective signal processing circuits, the horizontal synchronization signal Ext_H is delayed by eight clocks. In this case, the timing of the horizontal synchronization signal Ext_H after the delay becomes the timing of the same vertical period and field period even if the maximum four-clock skew is produced. Accordingly, obtaining the vertical synchronization signal Ext_V and the frame signal Ext_FLD is performed at an edge of the delayed horizontal synchronization signal Ext_H, and the obtained signals are output as a new vertical synchronization signal Ext_V and a frame signal Ext_FLD. By doing so, the skew effect can be prevented even if a skew is produced between the respective signal processing circuits. Further, since the delay of the horizontal synchronization signal Ext_H is performed on the basis of the system clock signal SCLK from the oscillator 45-A, it is not necessary for the signal processing circuit control unit 40 to supply the clock signal together with the horizontal synchronization signal Ext_H, the vertical synchronization signal Ext_V, and the frame signal Ext_FLD.

If the chip configuration control signal MC_EN indicates the operation in the multi-chip configuration, the signal selection unit 222 selects the horizontal synchronization signal Ext_H, the vertical synchronization signal Ext_V, and the frame signal Ext_FLD which are supplied from the skew compensation unit 221, and outputs the selected signals to the read control signal generation unit 224. Further, in the case where the operation in the single-chip configuration is indicated, the signal selection unit 222 selects and outputs the horizontal synchronization signal IW_H, the vertical synchronization signal IW_V, and the frame signal IW_FLD which correspond to the image signal IW_Data to the read control signal generation unit 224.

The write frame identification signal WF_ID_0 from the write control signal generation unit 211 and the frame identification signal EF_ID from the signal processing circuit control unit 40 are supplied to the signal selection unit 223. If it is indicated by the chip configuration control signal MC_EN supplied from the system control unit to perform the image display in the multi-chip configuration, the signal selection unit 223 selects the frame identification signal EF_ID that is supplied from the signal processing circuit control unit 40. Further, if it is indicated to perform the image display in the single-chip configuration, the signal selection unit 223 selects the write frame identification signal WF_ID_0. The signal selection unit 223 outputs the selected frame identification signal to the write address generation unit 212 and the read control signal generation unit 224 as the frame identification signal WF_ID. Further, if the image signals that are supplied to the signal processing circuits 20-A to 20-D are asynchronous with one another and can correspond to another format or frame rate as in a third display mode to be described later. The frame identification signal EF_ID may not be a signal which is synchronous with the image signals supplied to the signal processing circuits 20-A to 20-D. Accordingly, even if it is indicated by the chip configuration control signal MC_EN to perform the image display in the multi-chip configuration in the third display mode, the signal selection unit 223 selects the write frame identification signal WF_ID_0.

For example, in the case of the chip configuration control signal MC_EN [1:0]=[x:1], the signal selection unit 222 selects the horizontal synchronization signal Ext_H, the vertical synchronization signal Ext_V, and the frame signal Ext_FLD. In the case of the chip configuration control signal MC_EN [1:0]=[x:0], the signal selection unit 222 selects the horizontal synchronization signal IW_H, the vertical synchronization signal IW_V, and the frame signal IW_FLD. In the case of the chip configuration control signal MC_EN [1:0]=[1:x], the signal selection unit 223 selects the frame identification signal EF_ID. In the case of the chip configuration control signal. MC_EN [1:0]=[0:x], the signal selection unit 223 selects the write frame identification signal WF_ID_0. Here, in the case of using the multi-chip configuration, the chip configuration control signal becomes MC_EN[1:0]=[1:1] in the first or second display mode, and the chip configuration control signal becomes MC_EN[1:0]=[0:1] in the third display mode.

The read control signal generation unit 224 generates the horizontal read timing signal RT_H and the vertical read timing signal RT_V on the basis of the synchronization signal selected by the signal selection unit 222. The read control signal generation unit 224 supplies the generated signals to the read address generation unit 225 together with the frame signal RT_FLD that is synchronous with the signals. Further, the read control signal generation unit 224 generates and supplies the read enable signal RD_EN to the frame memory 202 and the read address generation unit 225. Further, the read control signal generation unit 224 generates the read frame identification signal RF_ID on the basis of the frame identification signal WF_ID supplied from the signal selection unit 223, and supplies the generated read frame identification signal RF_ID to the read address generation unit 225. Further, in a line jitter mode, the horizontal read timing signal RT_H is generated by free-running. The line jitter mode is a mode in which, since the display apparatus handles a frame rate signal over a wide frequency range, the vertical read timing signal RT_V of the output is generated by self-running the horizontal read timing signal RT_H of the output horizontal frequency and receiving the input vertical synchronization signal as the horizontal read timing signal RT_H. Accordingly, in the line jitter mode, the number of lines per frame is varied. Further, the read control signal generation unit 224 controls the read frame depending on whether or not a LowLatency mode is effective on the basis of a LowLatency enable signal LL_EN.

In the case where the reading of the image signal is permitted by means of the read enable signal RF_EN, the read address generation unit 225 generates the read address signal R_ADR on the basis of the horizontal read timing signal RT_H, the vertical read timing signal RT_V, the frame signal RT_FLD, and the read frame identification signal RF_ID. The read address generation unit 225 supplies the generated read address signal R_ADR to the frame memory 202, and reads the image signal that corresponds to the read frame identification signal RF_ID from the frame memory 202 to output the image signal.

### 1-2. Operation of First Embodiment

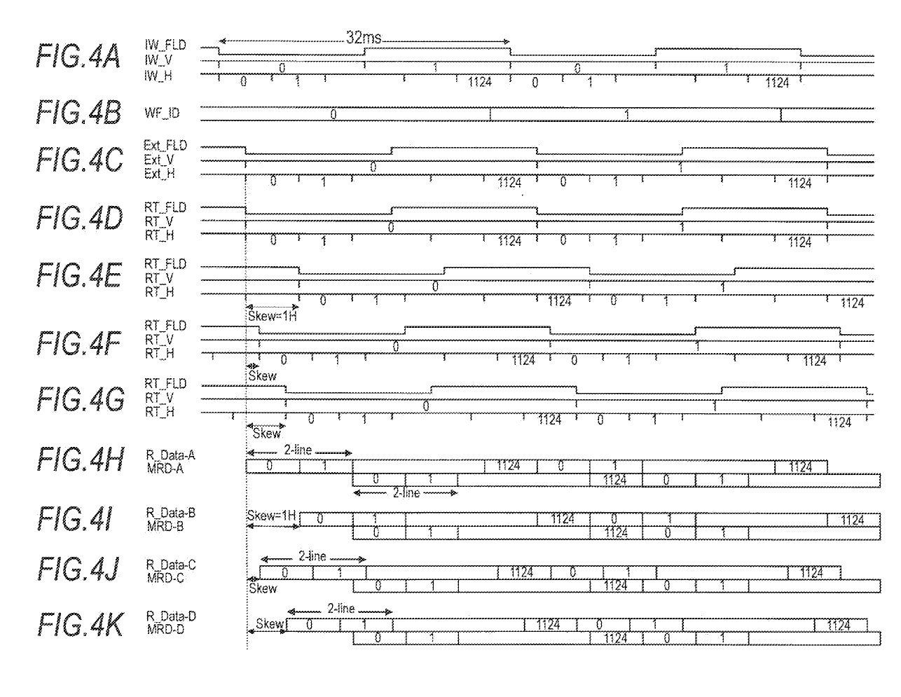

Next, the operation of the first embodiment will be described. FIGS. 4A to 4K are timing diagrams illustrating the operation of signal processing circuits. FIG. 4A shows a frame signal IW_FLD of an image signal IW_Data, a vertical synchronization signal IW_V, and a horizontal synchronization signal IW_H which are input to respective signal processing circuits 20-A to 20-D. FIG. 4B shows a frame identification signal WF_ID. FIG. 4C shows a horizontal synchronization signal Ext_H, a vertical synchronization signal Ext_V, and a frame signal Ext_FLD which are supplied from a signal processing circuit control unit 40 to the respective signal processing circuits 20-A to 20-D.

In a line jitter mode, the read control signal generation unit 224 of the signal processing circuit generates a horizontal read timing signal RT_H by free-running. Accordingly, the horizontal read timing, signal RT_H may produce a skew of maximum one, line. FIG. 4D shows a frame signal RT_FLD, a vertical read timing signal RT_V, and a horizontal read timing signal RT_H, which are generated by the read control signal generation unit 224 of the signal processing circuit 20-A. Here, if the phase of the horizontal read timing signal RT_H generated by the signal processing circuit 20-A coincides with the phase of the horizontal synchronization signal Ext_H supplied from the signal processing circuit control unit 40, the image signal output from the signal processing circuit 20-A is synchronous with the signal that is supplied from the signal processing circuit control unit 40 to the respective signal processing circuits.

FIG. 4E shows a frame signal RT_FLD, a vertical read timing signal RT_V, and a horizontal read timing signal RT_H, which are generated by the read control signal generation unit 224 of the signal processing circuit 20-B. If the horizontal read timing signal RT_H generated by the signal processing circuit 20-B produces maximum skew with respect to the supplied horizontal synchronization signal Ext_H, the image signal output from the signal processing circuit 20-B becomes a signal that is delayed by one line with respect to the signal supplied from the signal processing circuit control unit 40.

FIG. 4F shows a frame signal. RT_FLD, a vertical read timing signal RT_V, and a horizontal read timing signal RT_H, which are generated by the read control signal generation unit 224 of the signal processing circuit 20-C. Further, FIG. 4G shows a frame signal RT_FLD, a vertical read timing signal RT_V, and a horizontal read timing signal RT_H, which are generated by the read control signal generation unit 224 of the signal processing circuit 20-D. In the same manner as the image signals output from the signal processing circuits 20-A and 20-B, the image signals output from the signal processing circuits 20-C and 20-D become signals that are delayed depending on skews of the generated horizontal read timing signal RT_H and the supplied horizontal synchronization signal Ext_H.

FIG. 4H shows the operation of the line buffer 30-A. As shown in FIG. 4H, the line buffer 30-A sequentially stores the image signal R_Data-A read in the timing illustrated in FIG. 4D. FIG. 4I shows the operation of the line buffer 30-B. As shown in FIG. 4I, the line buffer 30-B sequentially stores the image signal R_Data-B read in the timing illustrated in FIG. 4E. FIG. 4J shows the operation of the line buffer 30-C. As shown in FIG. 4J, the line buffer 30-C sequentially stores the image signal R_Data-C read in the timing illustrated in FIG. 4F. FIG. 4K shows the operation of the line buffer 30-B. As shown in FIG. 4J, the line buffer 30-D sequentially stores the image signal R_Data-D read in the timing illustrated in FIG. 4G.

Further, the image signals stored in the line buffers 30-A to 30-D, as shown in FIGS. 4H to 4K, are read after time corresponding to two lines elapses from the write of the image signal R_Data-A based on the timing signal supplied from the signal processing circuit 20A. As described above, if the image signals are read from the line buffers 30-A to 30-D, the image signals MRD-A to MRD-D output from the line buffers 30-A to 30-D become phase-coincident signals.

That is, it is not necessary to install frame buffers having a capacity of =two frames for each signal processing circuit, but only by installing a line buffer having a capacity of two lines for each signal processing circuit, it becomes possible to make the phases of the image signals output from the respective signal processing circuits coincide with each other. For example, even if an output of another signal processing circuit produces a skew having an advanced phase of maximum one line or even if an output of still another signal processing circuit produces a skew having a late phase of maximum one line, for example, with respect to the output of the signal processing circuit 20-A, it is possible to make the phases of the image signals output from the respective signal processing circuits coincide with each other.

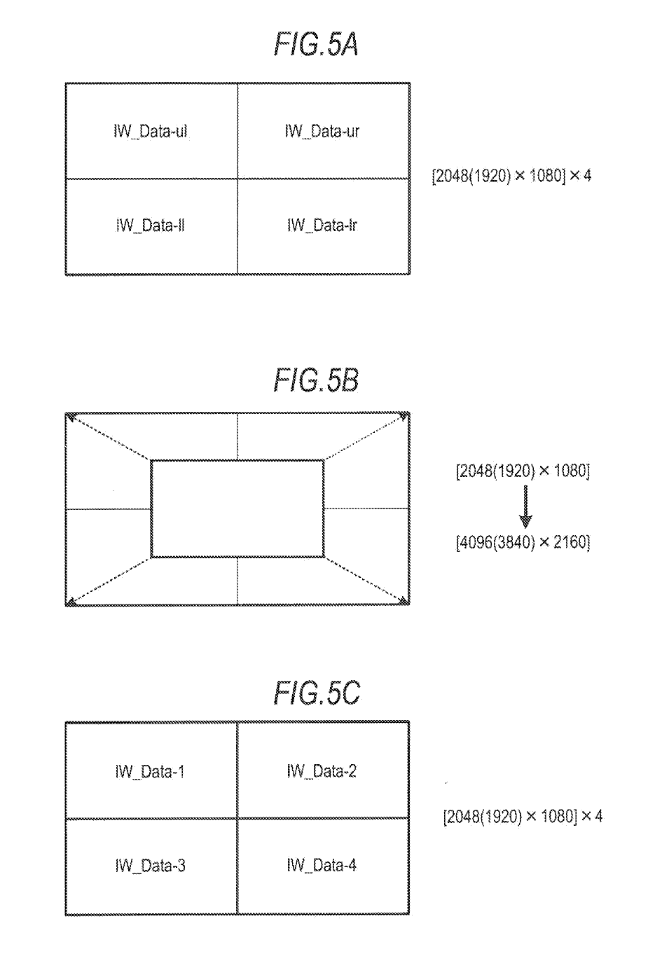

FIGS. 5A to 5C show display modes as examples of tiling process. FIG. 5A shows a first display mode, FIG. 5B shows a second display mode, and FIG. 5C shows a third display mode.

The first display mode is a mode in which one screen is divided into four display areas ([2048 (1920) pixels×1080 lines×4] through division of one screen into two display areas in the vertical direction and in the horizontal direction, respectively, and 4K image signals are supplied to the respective signal processing circuits of the four divided areas. For example, an image signal IW_Data-ul that corresponds to the upper left display area is supplied to the signal processing circuit 20-A. Further, an image signal IW_Data-ur that corresponds to the upper right display area is supplied to the signal processing circuit 20-B, an image signal IW_Data-ll that corresponds to the lower left display area is supplied to the signal processing circuit 20-C, and an image signal IW_Data-lr that corresponds to the lower right display area is supplied to the signal processing circuit 20-D.

The second display mode is a mode in which 2K image signals, that is, image signals of [2048 (1920) pixels×1080 lines] are supplied to the respective signal processing Circuits, and the image signal of the display area is cut out and expanded. For example the signal processing circuit 20-A performs image display of the upper left area in 4K×2K image display by cutting out the image signal of the upper left area from the 2K image signal and doubling each aspect.

The third display mode is a mode in which 2K independent image signals, that is, image signals of [2048 (1920) pixels×1080 lines] are supplied to the respective signal processing circuits, and 2K×1K image display is performed, resulting in that the 4K×2K image display is performed as a whole. Further, the image signals IW_Data-1 to IW_Data-4 are different image signals, and the respective image signals may be asynchronous with each other or may have different frame frequencies.

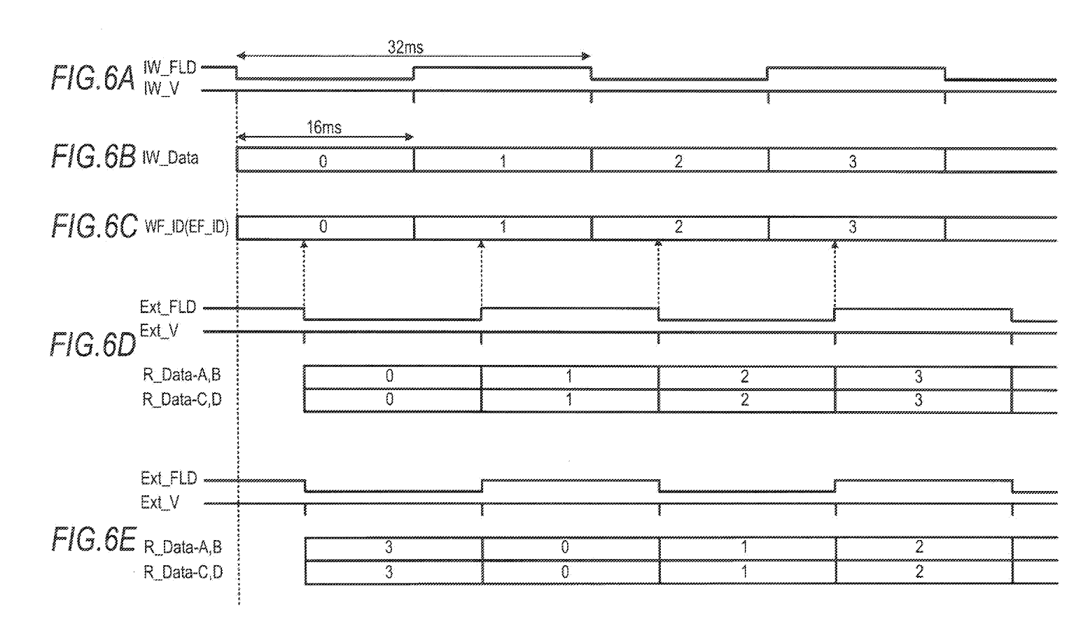

FIGS. 6A to 6E are timing diagrams illustrating the operation in the first display mode. FIG. 6A shows a frame signal IW_FLD, a vertical synchronization signal IW_V, and a horizontal synchronization signal IW_H of an image signal IW_Data, which are input to respective signal processing circuits 20-A to 20-D. FIG. 6B shows an image signal IW_Data. FIG. 6C shows a frame identification signal WF_ID (=EF_ID) selected by the signal selection unit 223.

FIG. 6D shows a LowLantency mode, and FIG. 6E shows an operation in a typical mode. The signal processing circuits 20-A and 20-B and the signal processing circuits 20-C and 20-D read the image signals as described above on the basis of the synchronization signal or a frame signal supplied from the signal processing circuit control unit 40. That is, as described above using FIGS. 4A to 4K, in the case where skews are produced between the signal processing circuits, the signal processing circuit control unit 40 receives the vertical synchronization signal Ext_V in the timing that is delayed over the maximum skew amount in consideration of the skews. The respective signal processing circuits asynchronously receive the vertical synchronization signal Ext_V after the skew compensation, generate the vertical read timing signal RT_V on the basis of the received vertical synchronization signal Ext_V, and read the image signal from the frame memory 202. Here, in the LowLatency mode shown in FIG. 6D, the written image signal is read before the write of the image signal of one frame is completed, and thus the delay of the image signal is reduced. Further, in the typical mode shown in FIG. 6E, the written image signal is read after the write of the image signal of one frame is completed.

As described above, in the case of the first display mode, even if a skew of the input image signal is produced between the signal processing circuits, the phases of the vertical synchronization signal Ext_V, the horizontal synchronization signal Ext_H, and the frame signal Ext_FLD are adjusted, and the image signals are output on the basis of the synchronization signals after the adjustment. Accordingly, the image signals can be output from the respective signal processing circuits without being affected by the skew.

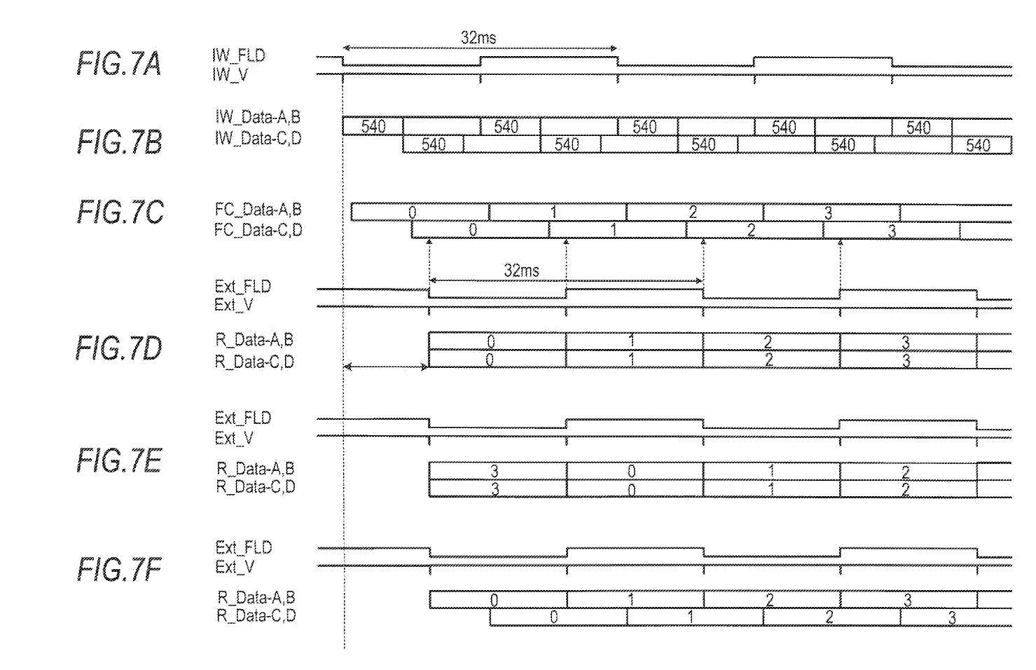

FIGS. 7A to 7F are timing diagrams illustrating the operation in the second display mode. FIG. 7A shows a frame signal IW_FLD of an image signal IW_Data and a vertical synchronization signal IW_V, which are input to respective signal processing circuits 20-A to 20-D. FIG. 7B shows an image signal input to the signal processing circuit. Image signals IW_Data-A and B for initial 540 lines of one frame period are input to the signal processing circuits 20-A and 20-B, and image signal IW_Data-C and D for the subsequent 540 lines are input to the signal processing circuits 20-C and 20-D. FIG. 7C shows the image signals processed by the signal processing circuits 20-A and 20-B and the image signals processed by the signal processing circuits 20-C and 20-D. In the case of the second display mode, for example, the image signals for 540 lines are expanded and processed as the image signals FC_Data-A and B, FC_Data-C and D for one frame.

FIG. 7D shows a LowLantency mode, and FIG. 7E shows an operation in a typical mode. The signal processing circuits 20-A and 20-B write the expanded image signals in frame memories and read the image signals as described above on the basis of the synchronization signal or the frame signal supplied from the signal processing circuit control unit 40. In the same manner, the signal processing circuits 20-C and 20-D write the expanded image signals in the frame memories and read the image signals as described above on the basis of the synchronization signal or the frame signal supplied from the signal processing circuit control unit 40. Further, the phases of the signals which are supplied from the signal processing circuit control unit 40 to the respective signal processing circuits are adjusted, and the reading of the image signals is performed in synchronization manner in the signal processing circuits 20-A to 20-D after the expanded image signals are written in the signal processing-circuits 20-C and 20-D. Here, in the LowLatency mode, the written image signal is read before the write of the image signal of one frame is completed, and thus the delay of the image signals R_Data-A, B, R_Data-C, and D is reduced. Further, in the typical mode, the written image signal is read after the write of the image signal of one frame is completed, and the image signals R_Data-A, B, R_Data-C, and D are output. Further, FIG. 7F shows the image signals output from the existing signal processing circuits and the image signals R_Data-A, B, R_Data-C, and D read from the frame Memories. In the existing signal processing circuits, the image signals R_Data-C and D has a delay of ½ of a frame period with respect to the image signals R_Data-A and B. However, in the signal processing circuits according to the embodiment of the present disclosure can output image signals without causing the delay of ½ of a frame period as illustrated in FIGS. 7D and 7E.

As described above, using the signal processing circuits according to the embodiment of the present disclosure, in the case of the second display mode, the signal processing circuits can output the image signals without causing a phase difference of ½ of a vertical period. Further, since the image signals can be output without causing the phase difference of ½ of the vertical period, the above-described LowLatency mode operation becomes possible.

Further, even in the case of the third display mode, it is not necessary to install frame buffers for two frames as in the related art. Further, even in the case where the respective image signals supplied to the signal processing circuits 20-A to 20-D are asynchronous with each other or have different frame frequencies, the signals written in the frame memories are synchronously read on the basis of the signals that are supplied from the signal processing circuit control unit 40 to the respective signal processing circuits. Accordingly, the image signals can be synchronously output from the signal processing circuits 20-A to 20-D.

### 2. Second Embodiment

In the first embodiment, system clock signals are supplied from oscillators installed for respective signal processing circuits. However, in this embodiment, by synchronizing the system clock signals supplied to the respective signal processing circuits, the capacity of line buffers installed at the downstream of the signal processing circuits can be additionally reduced.

### 2-1. Configuration of Second Embodiment

Next, a case where the system clock signals supplied to the respective signal processing circuits are synchronized with each other will be described as the second embodiment.

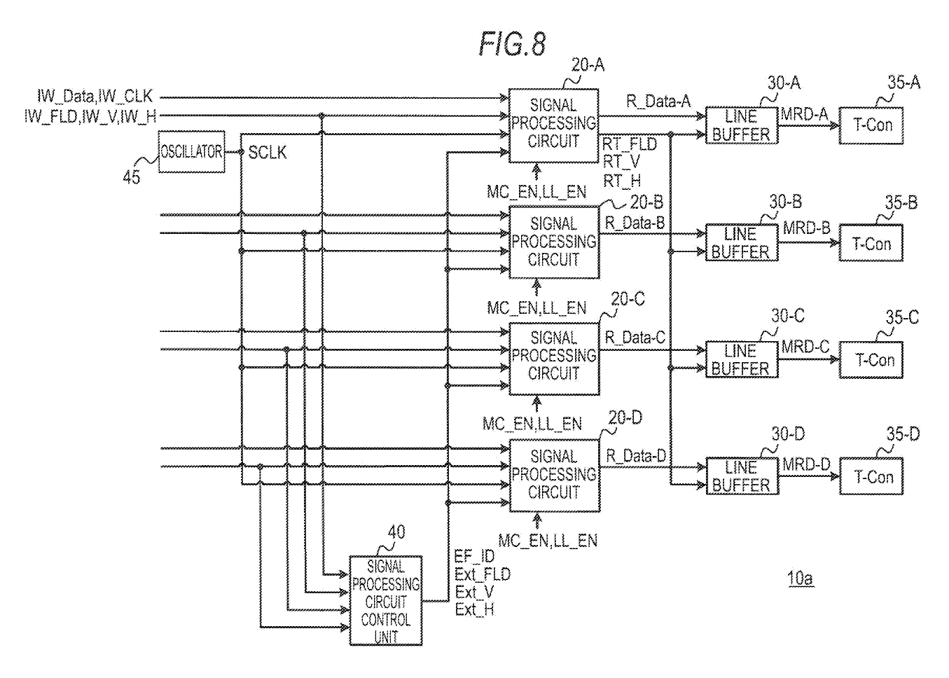

FIG. 8 is a diagram illustrating the configuration of the second embodiment A display apparatus 10a includes signal processing circuits 20-A to 20-D, line buffers 30-A to 30-D, timing control circuits 35-A to 35-D, a signal processing circuit control unit 40, and an oscillator 45.

The signal processing circuits 20-A to 20-D process image signals that correspond to respective display areas. For example, one screen is divided into four display areas on the upper, lower, left, and right sides, and the signal processing circuit 20-A processes the image signal that corresponds to, for example, the upper left display area. In the same manner, the signal processing circuit 20-B processes the image signal that corresponds to, for example, the upper right display area, the signal processing circuit 20-C processes the image signal that corresponds to, for example, the lower left display area, and the signal processing circuit 20-D processes the image signal that corresponds to, for example, the lower right display area.

An image signal IW_Data, a clock signal IW_CLK that corresponds to the image signal IW_Data, a horizontal synchronization signal IW_H, a vertical synchronization signal IW_V, and a frame signal IW_FLD are supplied to the signal processing circuit 20-A. Further, a horizontal synchronization signal Ext_H, a vertical synchronization signal Ext_V, a frame signal Ext_FLD, and a frame identification signal EF_ID are supplied from the signal processing circuit control unit 40 to be described later to the signal processing circuit 20-A. Further, a chip configuration control Signal MC_EN that indicates whether an operation that corresponds to a multi-chip configuration or a single-chip configuration is performed is supplied from a system control unit (not illustrated) to the signal processing circuit 20-A.

The signal processing circuit 20-A processes the image signal that corresponds to the display area through capturing the image signal IW_Data on the basis of the clock signal IW_CLK, the horizontal synchronization signal IW_H, the vertical synchronization signal IW_V, and the frame signal IW_FLD. In the case of performing an operation that corresponds to the multi-chip configuration on the basis of the chip configuration control signal MC_EN, the signal processing circuit 20-A reads the image signal after the processing on the basis of the horizontal synchronization signal Ext_H, the vertical synchronization signal Ext_V, and the frame signal Ext_FLD, and outputs the read image signal to the line buffer 30-A as an image signal R_Data-A.

In the same manner as the signal processing circuit 20-A, the signal processing circuits 20-B to 20-D process image signals that correspond to the respective display areas and output the image signals after the signal processing to the line buffers 30-B to 30-D. Further, in the case of performing an operation that corresponds to the single-chip configuration according to the chip configuration control signal MC_EN, the signal processing circuits 20-A to 20-D read the image signals on the basis of the horizontal synchronization signal IW_H, the vertical synchronization signal IW_V, and the frame signal IW_FLD.

The image signals stored in the line buffers 30-A to 30-D are synchronously read on the basis of a horizontal read timing signal RT_H, a vertical read timing signal RT_V, and a frame signal RT_FLD, and are supplied to the timing control circuits 35-A to 35-D. The timing control circuit 35-A receives the image signal read from the line buffer 30-A, and outputs the received image signal to a driver (not illustrated) of a display device in a predetermined format and as a timing signal. In the same manner, the timing control circuits 35-B to 35-D receive the image signals read from the ling buffers 30-B to 30-D, and output the received signals to the driver (not illustrated) of the display device in a redetermined format and as timing signals.

In the case of using a signal processing circuit with a multi-chip configuration, the signal processing circuit control unit 40 generates and supplies the horizontal synchronization signal Ext_H, the vertical synchronization signal Ext_V, the frame signal Ext_FLD, and the frame identification signal EF_ID to the signal processing circuits 20-A to 20-D.

The oscillator 45 generates a system clock signal SCLK that is a reference frequency signal for operating the signal processing circuits 20-A to 20-D.

### 2-2. Operation of Second Embodiment

In the display apparatus 10a as configured above, the signal processing circuit measures the phase relationship between the horizontal read timing signal RT_H generated by self-running and the horizontal synchronization signal Ext_H supplied from the signal processing circuit control unit 40. Further, the signal processing circuit measures the phase relationship between the vertical read timing signal RT_V and the vertical synchronization signal Ext_V supplied from the signal processing circuit control unit 40. For example, a phase difference measuring function is installed in the signal selection unit 222, and the measurement result is output to the read control signal generation unit 224.

Here, in the case where the system clock signals SCLK are synchronous with each other, the signal processing circuit control unit 40 generates the synchronization signal and the like on the basis of the system clock signals, and thus the measured phase difference is fixed to the respective signal processing circuits. Accordingly, the read control signal generation unit 224 generates the horizontal read timing signal RT_H and the vertical read timing signal RT_V so that the phase difference, for example, becomes less than 0.1H, and thus the phase difference of the image signals output from the respective signal processing circuits becomes less than 0.2H. Accordingly, even though the memory capacity of the line buffer that is installed in the downstream of the signal processing circuit corresponds to 0.2H, the phases of the image signals output from the respective signal processing circuits coincide with each other. That is, the capacity of the line buffer installed in the downstream of the signal processing circuit can be additionally reduced.

### 3. Third Embodiment

In the first embodiment and the second embodiment, the phase difference of the image signals output from the signal processing circuits is reduced through reading the image signals from the frame memory 202 to the respective signal processing circuits on the basis of the signal that is supplied from the signal processing circuit control unit 40. Here, by controlling the writing of the image signal in the frame memory 202 or reading of the written image signal, the image display can be stopped through, only the display apparatus to switch the displayed image from a moving image to a still image.

### 3-1. Configuration of Third Embodiment

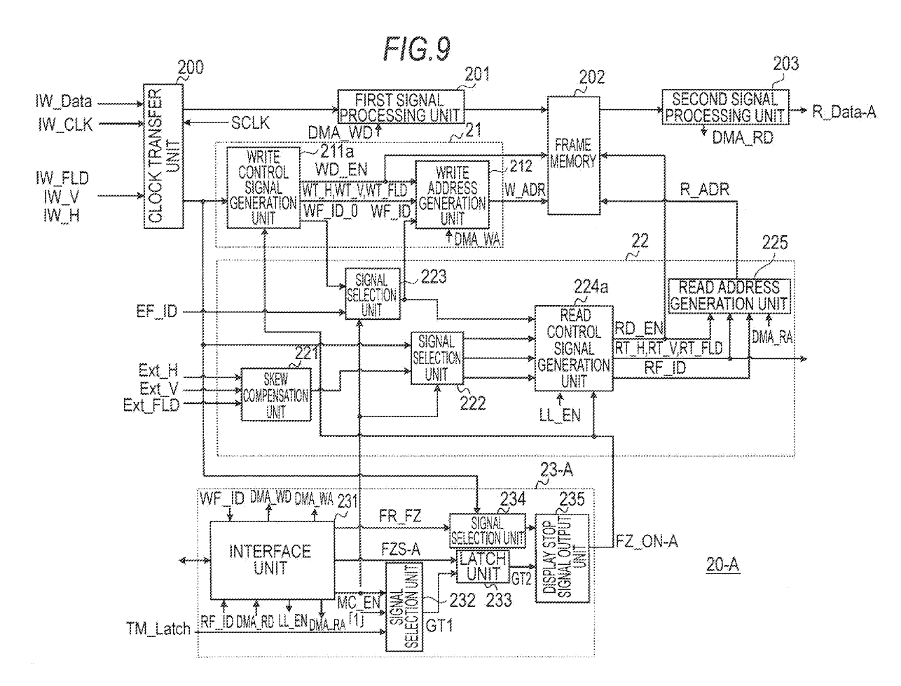

FIG. 9 is a diagram illustrating the configuration of a signal processing unit having a display stop function as a configuration according to the third embodiment. Further in FIG. 9, the same reference numerals are given to portions corresponding to FIG. 3. Since the signal processing circuits 20-A to 20-D are considered to have the same configuration, explanation will hereinafter be made only with respect to the signal processing circuit 20-A.

The image signal IW_Data is supplied to a crock transfer unit 200. The clock transfer unit 200 performs transfer of the clock signal, and makes the image signal IW_Data, the horizontal synchronization signal IW_H, the vertical synchronization signal IW_V, and the frame signal IW_FLD be in synchronization with the system clock signal SCLK, from the clock signal IW_CLK. The clock transfer unit 200 outputs the image signal IW_Data after the clock transfer to a first signal processing unit 201. Further, the clock transfer unit 200 outputs the horizontal synchronization signal IW_H, the vertical synchronization signal IW_V, and the frame signal IW_FLD after the clock transfer to a write control signal generation unit 211a of a write control unit 21, a signal selection unit 222 of a read control unit 22, and a signal selection unit 234 of a display stop control unit 23-A.

The first signal processing unit 201 performs various processes that do not use a memory, for example, luminance correction and color correction processes, with respect to the image signal IW_Data according to an instruction from a system control unit, and supplies the image signal after the processing to a frame memory 202. The frame memory 202 is connected to a second signal processing unit 203 that generates a new image signal using the stored image signal. The second signal processing unit 203 performs various signal processes, for example, interlace/progressive conversion, size conversion, and double speed conversion processes using the image signal stored in the frame memory 202 according to the instruction from the system control unit.

The write control signal generation unit 211a of the write control unit 21 generates a horizontal write timing signal WT_H and a vertical write timing signal WT_V on the basis of the horizontal synchronization signal IW_H, the vertical synchronization signal IW_V, and the frame signal IW_FLD. The write control signal generation unit 211a supplies the generated signals to a write address generation unit 212 together with the frame signal WT_FLD that is synchronized with the signals. Further, the write control signal generation unit 211a generates and supplies a write enable signal WD_EN to the frame memory 202 and the write address generation unit 212. Further, the write control signal generation unit 211a generates a write frame identification signal WF_ID_0 in a self-running manner on the basis of the frame signal IW_FLD, and supplies the write frame identification signal WF_ID_0 to the signal selection unit 223. Further, in the case where an instruction for stopping the display by means of a display stop signal is provided from a display stop control unit 23 to be described later, for example, the write control signal generation unit 211a stops the generation of the frame identification signal WF_ID_0, and stops the writing of the image signal in the frame memory 202.

In the case where the write permission is performed by means of the write enable signal WD_EN, the write address generation unit 212 generates a write address signal W_ADR on the basis of the horizontal write timing signal WT_H, the vertical write timing signal WT_V, the frame signal WT_FLD, and the frame identification signal WF_ID supplied from the signal selection unit 223. The write address generation unit 212 supplies the generated write address signal W_ADR to the frame memory 202, and stores the image signal output from the first signal processing unit 201 in the frame memory 202.

In the case of performing image display in a multi-chip configuration using a plurality of signal processing circuits, a skew compensation unit 221 of the read control unit 22 prevents an image due to a skew which may be produced in input image signals between the respective signal processing circuits. The skew compensation unit 221 adjusts the timing so that the image signals after the signal processing can be output from the respective signal processing circuits with the phase difference reduced, on the basis of the horizontal synchronization signal Ext_H, the vertical synchronization signal Ext_V, and the frame signal Ext_FLD which are supplied from the signal processing circuit control unit 40. The skew compensation unit 221 outputs the respective signals after the timing adjustment to the signal selection unit 222. Further, since the delay of the horizontal synchronization signal Ext_H is performed on the basis of the system clock signal SCLK from the oscillator 45-A, it is not necessary for the signal processing circuit control unit 40 to supply the clock signal together with the horizontal synchronization signal Ext_H, the vertical synchronization signal Ext_V, and the frame signal Ext_FLD.

If the chip configuration control signal MC_EN indicates the operation in the multi-chip configuration, the signal selection unit 222 selects the horizontal synchronization signal Ext_H, the vertical synchronization signal Ext_V, and the frame signal Ext_FLD which are supplied from the skew compensation unit 221, and outputs the selected signals to the read control signal generation unit 224a. Further, in the case where the operation in the single-chip configuration is indicated, the signal selection unit 222 selects and outputs the horizontal synchronization signal IW_H, the vertical synchronization signal IW_V, and the frame signal IW_FLD which correspond to the image signal IW_Data to the read control signal generation unit 224a.

The write frame identification signal WF_ID_0 from the write control signal generation unit 211 and the frame identification signal EF_ID from the signal processing circuit control unit 40 are supplied to the signal selection unit 223. If it is indicated by the chip configuration control signal MC_EN supplied from the system control unit to perform the image display in the multi-chip configuration, the signal selection unit 223 selects the frame identification signal EF_ID that is supplied from the signal processing circuit control unit 40. Further, if it is indicated to perform the image display in the single-chip configuration, the signal selection unit 223 selects the write frame identification signal WF_ID_0. The signal selection unit 223 outputs the selected frame identification signal to the write address generation unit 212 and the read control signal generation unit 224 as the frame identification signal WF_ID. Further, if the image signals that are supplied to the signal processing circuits 20-A to 20-D are asynchronous with one another and can correspond to another format or frame rate as in the third display mode. The frame identification signal EF_ID may not be a signal which is synchronous with the image signals supplied to the signal processing circuits 20-A to 20-D. Accordingly, even if it is indicated by the chip configuration control signal MC_EN to perform the image display in the multi-chip configuration in the third display mode, the signal selection unit 223 selects the write frame identification signal WF_ID_0.

The read control signal generation unit 224a generates the horizontal read timing signal RT_H and the vertical read timing signal RT_V on the basis of the synchronization signal selected by the signal selection unit 222. The read control signal generation unit 224a supplies the generated signals to the read address generation unit 225 together with the frame signal RT_FLD that is synchronous with the signals. Further, the read control signal generation unit 224a generates and supplies the read enable signal RD_EN to the frame memory 202 and the read address generation unit 225. Further, the read control signal generation unit 224a generates the read frame identification signal RF_ID on the basis of the frame identification signal selected by the signal selection unit 223, and supplies the generated read frame identification signal RF_ID to the read address generation unit 225. Further, in a line jitter mode, the horizontal read timing signal RT_H is generated by free-running. Further, in the case where an instruction for stopping the display by means of a display stop signal is provided from the display stop control unit 23, for example, the read control signal generation unit 224a repeats reading of the same image signal from the frame memory 202 through repeating the generation of the same read frame identification signal RF_ID. Further, the read control signal generation unit 224a controls the read frame depending, on whether or not the LowLatency mode is effective on the basis of the LowLatency enable signal LL_EN.

In the case where the reading of the image signal is permitted by means of the read enable signal RD_EN, the read address generation unit 225 generates the read address signal R_ADR on the basis of the horizontal read timing signal RT_H, the vertical read timing signal RT_V, the frame signal RT_FLD, and the read frame identification signal RF_ID. The read address generation unit 225 supplies the generated read address signal R_ADR to the frame memory 202, and reads the image signal that corresponds to the read frame identification signal RF_ID from the frame memory 202 to output the image signal.

An interface (I/F) unit 231 of the display stop control unit 23-A generates a chip configuration control signal MC_EN depending on an instruction supplied from the system control unit, that is, whether an operation that corresponds to the multi-chip configuration or the single-chip configuration is performed. The interface unit 231 outputs the generated chip Configuration control signal MC_EN to the signal selection units 222, 223, and 232 and the read control signal generation unit 224a. Further, the interface unit 231 generates a display stop instruction signal FZS and a stop setting signal FR_FZ according to the instruction from the system control unit. The interface unit 231 outputs a display stop instruction signal FZS to a latch unit 233, and outputs the stop setting signal FR_FZ to the signal selection unit 234.

In the case of performing the image display in the multi-chip configuration on the basis of the chip configuration control signal MC_EN, the signal selection unit 232 selects a latch signal TM_Latch and outputs the latch signal TM_Latch to the latch unit 233 as a gate signal GT1. Further, in the case of performing the image display in the single-chip configuration, the signal selection unit 232 selects “1” and outputs the selected signal to the latch unit 233 as the gate signal GT1.

The latch unit 233 latches the display stop instruction signal FZS on the basis of the gate signal GT1, and outputs the latched signal to a display stop signal output unit 235 as a gate signal GT2.

The signal selection unit 234 selects the vertical synchronization signal IW_V or the frame signal IW_FLD according to the stop setting signal FR_FZ, and outputs the selected signal to the display stop signal output unit 235. If it is considered that the stop setting signal FR_FZ is, for example, “0”, the signal selection unit 234 selects and outputs the vertical synchronization signal IW_V. Further, if it is considered that the stop setting signal FR_FZ is, for example, “1”, the signal selection unit 234 selects and outputs the frame signal IW-FLD.

The display stop signal output unit 235 latches the display stop instruction signal FZS that is latched in the latch unit 233 in the timing of the signal selected by the signal selection unit 234 and outputs the latched display stop instruction signal FZS to the write control signal generation unit 211a and the read control signal generation unit 224a as a display stop control signal FZ_ON.

### 3-2. Operation of Third Embodiment

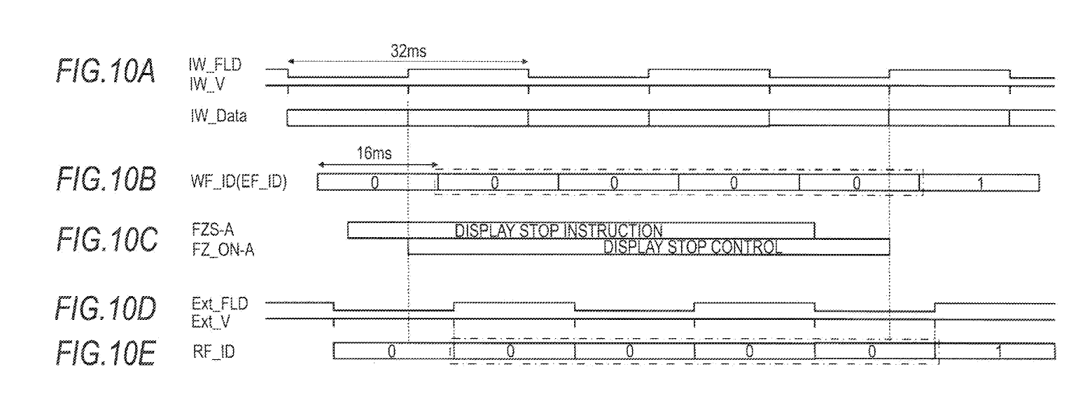

FIGS. 10A to 10E are timing diagrams illustrating the operation of a signal processing unit having a display stop function. FIG. 10A shows the image signal IW_Data, the frame signal IW_FLD of the image signal IW_Data, and the vertical synchronization signal IW-V. FIG. 10B shows the frame identification signal WF_ID generated by the write control signal generation unit 211a. FIG. 10C shows the display stop instruction signal FZS output from the interface unit 231 and the display stop control signal FZ_ON output from the display stop signal output unit 235. Further, FIG. 10D shows the vertical synchronization signal Ext_V and the frame signal Ext_FLD supplied froth the signal processing circuit control unit 40. Further, FIG. 10E shows the read frame identification signal RF_ID generated by the read control signal generation unit 224a.

If the display stop instruction signal FZS is latched and supplied to the display stop signal output unit 235, the display stop signal output unit 235 outputs the display stop instruction signal FZS in the timing on the basis of the signal selected by the signal selection unit 234 as the display stop control signal FZ_ON. For example, if the stop setting signal FR_FZ is considered to be “0”, the signal selection unit 234 selects the vertical synchronization signal IW_V, and the display stop signal output unit 235 outputs the display stop control signal FZ_ON in synchronization with the vertical synchronization signal IW_V. Accordingly, the write control signal generation unit 211a stops the writing of the image signal in the frame memory 202 through stopping the updating of the frame identification signal WF_ID as shown as a dashed-dotted line in FIG. 10B. Further, by means of the output of the display stop control signal FZ_ON, the read control signal generation unit 224a stops the updating of the read frame identification signal RF_ID, and repeatedly reads the image signal of which the read frame identification signal RF_ID is “0” as shown as a dashed-dotted line in FIG. 10E.

Thereafter, if the output of the display stop instruction signal FZS is stopped, the display stop signal output unit 235 stops the output of the display stop control signal FZ_ON in synchronization with the vertical synchronization signal IW_V. Further, as the output of the display stop control signal FZ_ON is stopped, the write control signal generation unit 211a restarts the updating of the frame identification signal WF_ID, and the read control signal generation unit 224a restarts the updating of the read frame identification signal RF_ID. Accordingly, the write control signal generation unit 211a stops the writing of the image signal during a period indicated by a dashed-dotted line in FIG. 10B, and then restarts the writing of the image signal. Further, the read control signal generation unit 224a repeatedly reads the image signal that corresponds to the same read frame identification signal RF_ID during a period indicated by a dashed-dotted line in FIG. 10E, and then restarts the reading of a new image signal through updating the read frame identification signals RF_ID in order. That is, a still image can be displayed during the period indicated by the dashed-dotted line in FIG. 10E.

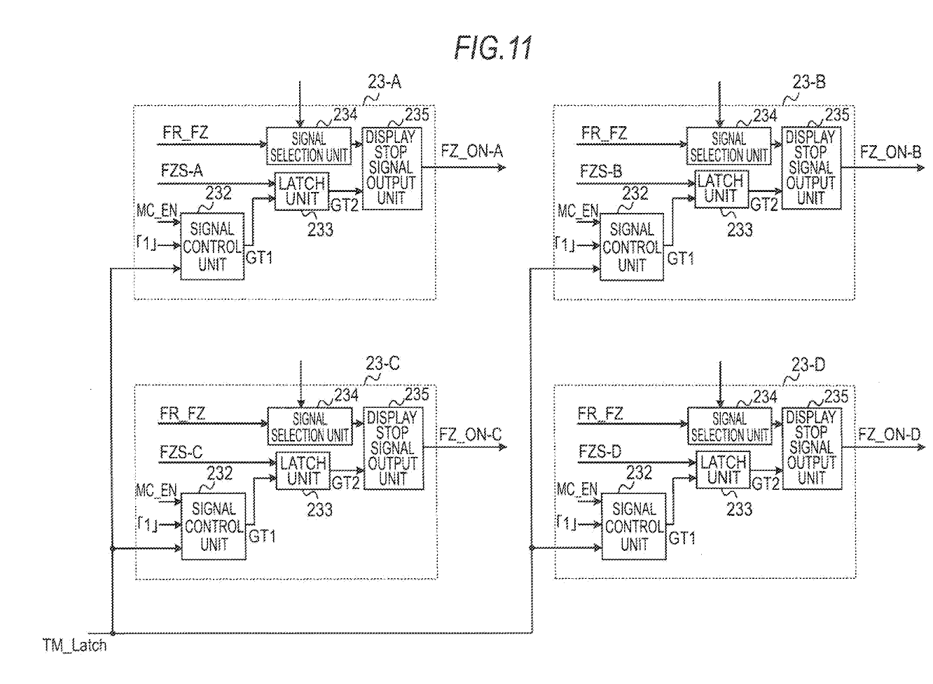

FIG. 11 shows display stop control units 23-A to 23-D of four signal processing circuits 20-A to 20-D. The latch signals TM_Latch are supplied to, the display stop control units 23-A to 23-D, and in the same timing, the display stop instruction signal FZS is latched to the latch unit 233 to be supplied to the display stop signal output unit 235. Accordingly, the display stop process of the signal processing circuits 20-A to 20-D can be synchronously performed.

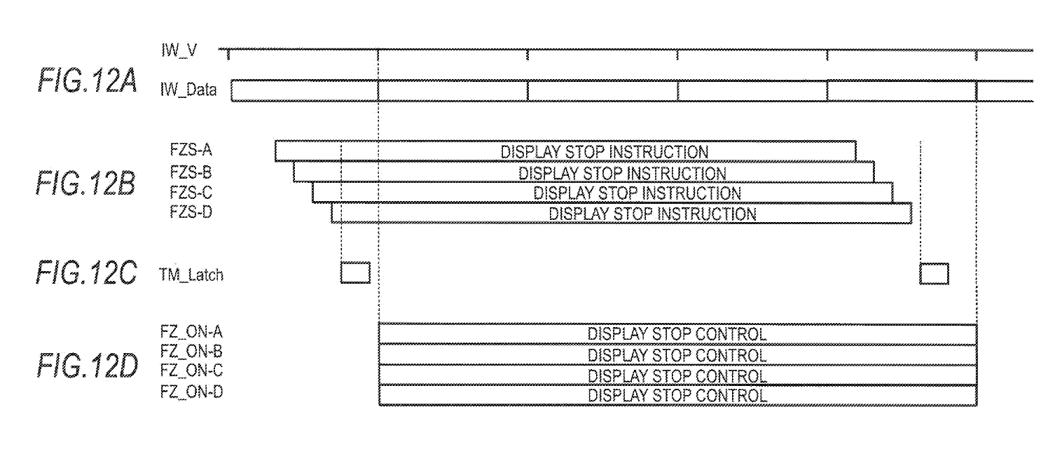

FIGS. 12A to 12D are timing diagrams illustrating the operation of four signal processing circuits 20-A to 20-D. FIG. 12A shows the image signal IW_Data and the vertical synchronization signal IW_V. FIG. 12B shows display stop instruction signals FZS-A to FZS-D supplied to the signal processing circuits 20-A to 20-D. The display stop instruction signals are asynchronously supplied from the system control unit and thus have phase differences as shown in the drawing. FIG. 12C shows the latch signal TM_Latch, and signal processing circuits 20-A to 20-D latch the display stop instruction signal FZS by means of the latch signal TM_Latch. FIG. 12D shows display stop control signals FZ_ON-A to FZ_ON-D generated by the signal processing circuits 20-A to 20-D. The display stop control signals are signals which are latched in the timing in synchronization with the display stop instruction signal, for example, the vertical synchronization signal IW_V, and the display stop control signals FZ_ON-A to FZ_ON-D generated by the respective signal processing circuits become synchronous signals as shown in the drawing.

Accordingly, in the case of perform high-resolution display in the multi-chip configuration, the plurality of signal processing circuits switch over to still image display through synchronization. Accordingly, even if the still image signal is not input to the display apparatus, the still image can be displayed for each area in the synchronous timing through supplying of the latch signal TM_Latch after supplying the display stop instruction signals to the respective signal processing circuits. Further, by supplying the latch signal TM_Latch after the completion of the display stop instruction signal, the still image display may switch over to a moving image display.

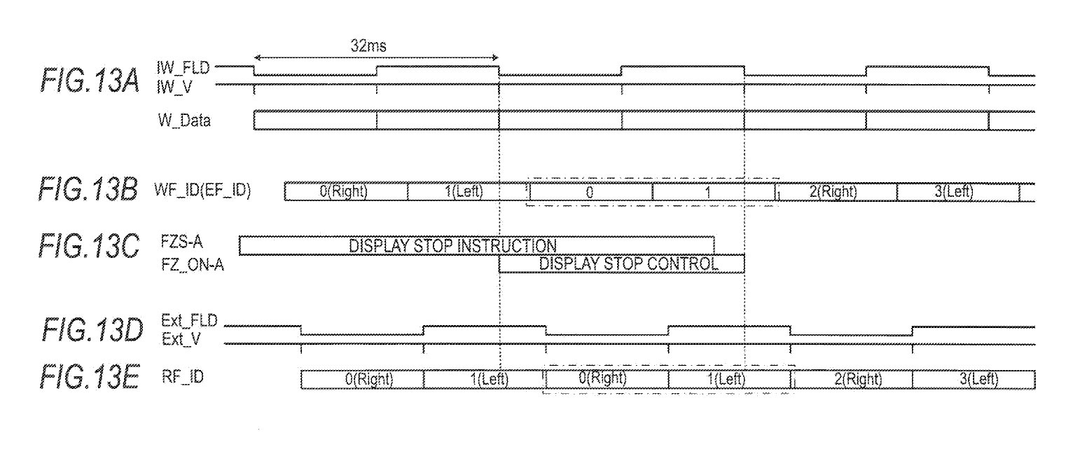

Further, the still image display may be applicable to a multi-viewpoint image. FIGS. 13A to 13E, for example, are timing diagrams illustrating the operation in the case where a field (frame) sequential type image signal is input to a signal processing circuit.

FIG. 13A shows the image signal IW_Data, the frame signal IW_FLD of the image signal IW_Data, and the vertical synchronization signal IW_V. FIG. 13B shows the frame identification signal WF_ID generated by the write control signal generation unit 211a. FIG. 13C shows the display stop instruction signal FZS output from the interface unit 231 and the display stop control signal FZ_ON output from the display stop signal output unit 235. Further, FIG. 13D shows the vertical synchronization signal Ext_V and the frame signal Ext_FLD supplied from the signal processing circuit control unit 40. Further, FIG. 13E shows the read frame Identification signal RF_ID generated by the read control signal generation unit 224a.

If the display stop instruction signal FZS is latched and supplied to the display stop signal output unit 235, the display stop signal output unit 235 outputs the display stop instruction signal FZS in the timing on the basis of the signal selected by the signal selection unit 234 as the display stop control signal FZ_ON. Here, in the case of performing still image display with the multi-viewpoint image, for example, the stop setting signal FR_FZ is considered to be “1”. In this case, the signal selection unit 234 selects the frame signal IW_FLD, and the display stop signal output unit 235 outputs the display stop control unit FZ_ON in synchronization with the frame signal IW_FLD. Accordingly, the write control signal generation unit 211a stops the writing of the image signal in the frame memory 202 through stopping the updating of the frame identification signal WF_ID as shown as a dashed-dotted line in FIG. 13B. Further, by means of the output of the display stop control signal FZ_ON, the read control signal generation unit 224a stops the updating of the read frame identification signal RF_ID, and repeatedly reads the image signal of which the read frame identification signals RF_ID are “0” and “1” as shown as a dashed-dotted line in FIG. 13E.

Thereafter, if the output of the display stop instruction signal FZS is stopped, the display stop signal output unit 235 stops the output of the display stop control signal FZ_ON in synchronization with the vertical synchronization signal IW_V. Further, as the output of the display stop control signal FZ_ON is stopped, the write control signal generation unit 211a restarts the updating of the frame identification Signal WF_ID, and the read control signal generation unit 224a restarts the updating of the read frame identification signal RF_ID. Accordingly, the write control signal generation unit 211a stops the writing of the image signal during a period indicated by a dashed-dotted line in FIG. 13B, and then restarts the writing of the image signal. Further, the read control signal generation unit 224a repeatedly reads the image signal that corresponds to the non-updated frame identification signal RF_ID during a period indicated by a dashed-dotted line in FIG. 13E, and then restarts the reading of a new image signal through updating the read frame identification signals RF_ID in order. That is, during the period indicated by the dashed-dotted line in FIG. 13E, the right viewpoint image signal and the left viewpoint image signal are repeatedly read, and thus even in the case of performing the multi-viewpoint image display, a still image can be displayed.

As described above, by performing the display stop control in synchronization with the frame signal and repeating the reading of the multi-viewpoint image signal for one frame, the multi-viewpoint image can be displayed as high-resolution still image in the desired timing even though the image signal of the multi-viewpoint still image is not input to the display apparatus. Accordingly, for example, 3D image evaluation can be efficiently performed.

In the third embodiment, it is exemplified that the image based on the image signal IW_Data is switched over from the moving image to the still image. However, in the first, display mode or the second display mode, the still image can be easily replaced by a desired still image through capturing and outputting the still image as a captured image signal or through supplying an image signal of a desired still image from an external device to the signal processing circuit.

In FIG. 9, a still image read signal DMA_RA that is supplied from the interface unit 231 of the display stop control unit 23-A to the read address generation unit 225 of the read control unit 22 is a signal that is output to an external device through capturing a still image stored in the frame memory 202. The image signal DMA_RD that is supplied from the second signal processing unit 203 to the interface (I/F) unit 231 is a captured image signal that is read from the frame memory 202 and is output to the external device.

The replacement image signal DMA_WD that is supplied from the interface unit 231 of the display stop control unit 23-A to the first signal processing unit 201 is a replacement image signal supplied from the external device. Further, the still image write signal DMA_WA that is supplied to the write address generation unit 212 of the write control unit 21 is a signal for storing the replacement image signal DMA_WD supplied from the external device in the frame memory 202.

The reading of the image signal DMA_RD from the frame memory 202 or the writing of the replacement image signal DMA_WD in the frame memory 202 may be easily performed using a DMA (Direct Memory Access) method.

Further, in the case of reading the image signal DMA_RD, for example, in the first display mode in the multi-chip configuration, the same frame identification signal is kept in the respective signal processing circuits using the frame identification signal EF_ID as the read frame identification signal RF_ID. Through doing so, in the case of capturing the image signal of the frame memory 202 into the external device in the DMA method, addresses that correspond to the frame identification signal become equal to each other. Accordingly, it is not necessary for the respective signal processing circuits to manage the frame identification signals, and the generation of the read address signal R_ADR becomes simplified. Further, in the case where the frame identification signal EF_ID is not used, since the frame identification signals when recording the image signal in the respective signal processing circuits are different from each other, the addresses that correspond to the frame identification signals become different from each other even in the case of reading the stored image signal. Accordingly, in comparison to a case where the frame identification signal EF_ID is used, the generation of the read address signal R_ADR is not simplified.

Further, in the case of writing the replacement image signal DMA_WD, for example, in the first display mode in the multi-chip configuration, the same frame identification signal is kept in the respective signal processing circuits using the frame identification signal EF-ID as the frame identification signal WF_ID. Through doing so, in the case of storing the image signal from the external device in the frame memory 202 in the DMA method, addresses that correspond to the frame identification signal become equal to each other. Accordingly, it is not necessary for the respective signal processing circuits to manage the frame identification signals, and the generation of the read address signal R_ADR becomes simplified.

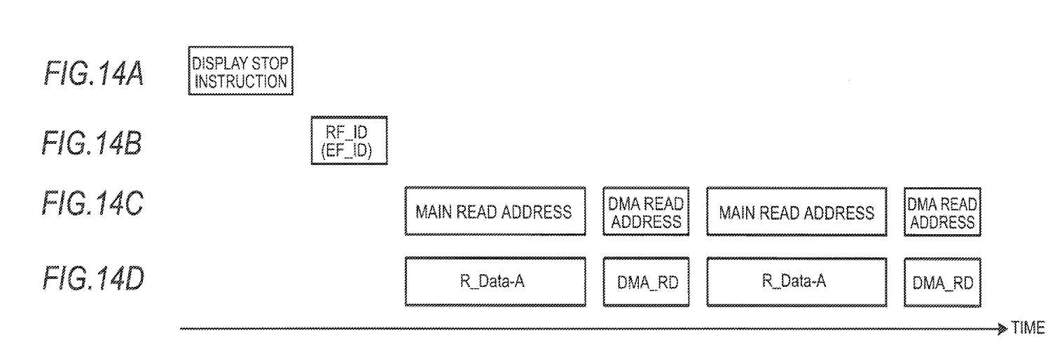

FIGS. 14A to 14D are timing diagrams in the case of capturing a still image. FIG. 14A shows the display stop instruction signal FZS. FIG. 14B shows the read frame identification signal RF_ID(=EF_ID), FIG. 14C shows the read address signal, and FIG. 14D shows the read image signal. Here, if the read address signal is a main read address signal based on the horizontal read timing signal RT_H, the vertical read timing signal RT_V, and the frame signal RT_FLD, the image signal R_Data-A is output. Further, if the read address signal is a DMA read address signal based on a still image read signal DMA_RA, the image signal DMA_RD read from the frame memory 202 is output to outside as the captured image signal.

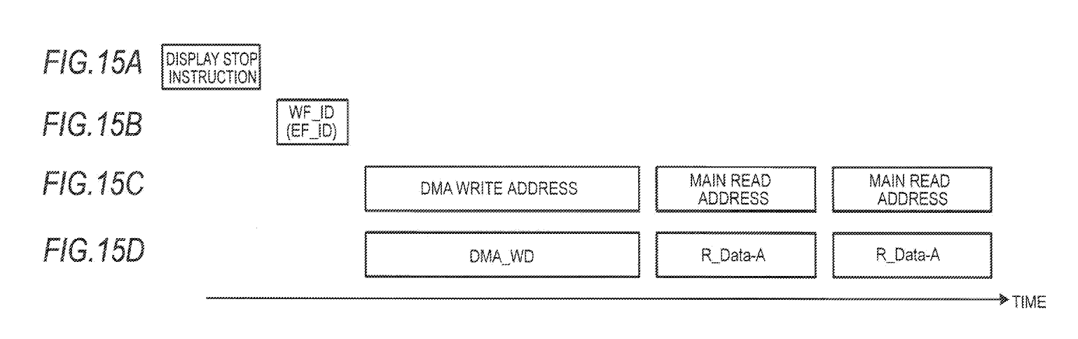

FIGS. 15A to 15D are timing diagrams in the case of replacing a still image. FIG. 15A shows the display stop instruction signal FZS. FIG. 15B shows the frame identification signal WF_ID(=EF_ID), FIG. 15C shows the write address signal and the read address signal, and FIG. 15D shows the image signal written in the frame memory 202 and an image signal read from the frame memory 202. Here, if the write address signal is a write address signal based on the still image write signal DMA_WA, the replacement image signal DMA_WD is stored in the frame memory 202. Thereafter, by reading the image signal on the basis of the main address signal using the frame identification signal EF_ID as the read frame identification signal RF_ID, the replacement image signal supplied from the external device is output as the image signal R_Data-A. That is, the still image supplied from the external device can be easily replaced by the still image that is displayed in the multi-chip configuration.

As described above, in the case of outputting the captured image signal of the still image to the external device in the multi-chip configuration or in the case of displaying the still image on the basis of the replacement image signal supplied from the external device, the image signal is read or written using the frame identification signal EF_ID. Accordingly, in the manner as the case where the respective signal processing circuits write or read the image signal through individually setting the frame identification signals, it is not necessary for the respective signal processing circuits to manage the frame identification signals, and addresses can be easily generated as described above.

Further, the present disclosure should not be understood to be limited to the above-described embodiments. Since the embodiments of the present disclosure disclose the technology in the form of examples, it is apparent to those skilled in the art that various modifications or alternatives can be made without departing from the gist of the present disclosure. That is, in order to determine the gist of the present disclosure, the appended claims should be taken into consideration.

Further, the present disclosure may have the following configurations.

(1) A signal processing circuit including:

a memory storing an image signal;

a write control unit generating a write control signal in synchronization with the input image signal and frame identification information, and storing the input image signal in the memory so that the input image signal corresponds to the frame identification information on the basis of the write control signal; and

a read control unit generating a read control signal through obtaining a vertical synchronization signal supplied from outside based on a timing, signal of an output horizontal frequency, and reading an image signal that corresponds to the frame identification information from the memory on the basis of the read control signal and the frame identification information supplied from outside.

(2) The signal processing circuit described in (1), wherein in the case of performing image display simultaneously using a plurality of signal processing circuits, the read control unit generates the read control signal and reads the image signal that corresponds to the frame identification information from the memory on the basis of the read control signal and the frame identification information.

(3) The signal processing circuit described in (1) or (2), wherein the read control unit detects a phase difference between a vertical synchronization signal generated on the basis of the timing signal of the output horizontal frequency and the vertical synchronization signal supplied from outside and a phase difference between the timing signal of the output horizontal frequency and a horizontal synchronization signal supplied from outside, adjusts phases of the timing signal of the output horizontal frequency and the vertical synchronization signal that is generated on the basis of the timing signal so that the phase differences are less than a predetermined value, and generates the read control signal using the signal after the adjustment.

(4) The signal processing circuit described in any one of (1) to (3), further including a skew compensation unit delaying a synchronization signal supplied from outside so that the image signal that corresponds to the frame identification information can be read from the memory on the basis of the read control signal and the frame identification information even if the input image signal and an input image signal input to another signal processing circuit produce skews.

(5) The signal processing circuit described in any one of (1) to (4), further including a display stop control unit obtaining a display stop instruction signal on the basis of an input latch signal when the display stop instruction signal is supplied and outputting the obtained display stop instruction signal to the write control unit and the read control unit,

wherein the write control unit stops storing the input image signal in the memory during a display stop period on the basis of the display stop instruction signal, and

the read control unit reads the image signal that corresponds to the frame identification information, which has been read before the display stop, during the display stop period on the basis of the display stop instruction signal.

(6) The signal processing circuit described in (5), wherein the display stop control unit obtains the display stop instruction signal on the basis of the input latch signal in the unit of a frame or in the unit of multiple frames.

(7) The signal processing circuit described in (5), wherein the read control unit reads the image signal that corresponds to the frame identification information from the memory on the basis of the frame identification information supplied from outside and outputs the read image signal to outside as a captured image signal.

(8) The signal processing circuit described in (5), wherein the write control unit stores a replacement image signal in the memory to correspond to the frame identification information on the basis of the frame identification information supplied from outside.

(9) The signal processing circuit described in (8), wherein the read control unit reads the replacement image signal stored in the memory to correspond to the frame identification information on the basis of the frame identification information supplied from outside.

(10) The signal processing circuit described in any one of (1) to (9), wherein the memory stores the image signal that is used for signal processing.

(11) A display apparatus including:

signal processing circuits for a plurality of display areas, that constitute one screen, which process image signals for the corresponding display areas, respectively,

wherein each of the signal processing circuits includes

a memory storing an image signal,

a write control unit generating a write control signal in synchronization with the input image signal and frame identification information, and storing the input image signal in the memory so that the input image signal corresponds to the frame identification information on the basis of the write control signal, and

a read control unit generating a read control signal through obtaining a vertical synchronization signal supplied from outside commonly to the respective signal processing circuits based on a timing signal of an output horizontal frequency, and reading an image signal that corresponds to the frame identification information from the memory on the basis of the read control signal and the frame identification information supplied from outside commonly to the respective signal processing circuits.

(12) The display apparatus described in (11), further including an oscillation unit generating a reference frequency signal,

wherein the oscillation unit supplies the generated reference frequency signal to the respective signal processing circuits, and

the read control unit of the signal processing circuit detects a phase difference between a vertical synchronization signal generated on the basis of the timing signal of the output horizontal frequency and the vertical synchronization signal supplied from outside and a phase difference between the timing signal of the output horizontal frequency and a horizontal synchronization signal supplied from outside, adjusts phases of the timing signal of the output horizontal frequency and the vertical synchronization signal that is generated on the basis of the timing signal so that the phase differences are less than a predetermined value, and generates the read control signal using the signal after the adjustment.

(13) The display apparatus described in (11) or (12), wherein the plurality of signal processing circuits includes a skew compensation unit delaying a synchronization signal supplied from outside so that the image signal that corresponds to the frame identification information can be read from the memory on the basis of the read control signal and the frame identification information even if the input image signals which are input to the plurality of signal processing circuits produce skews between the signal processing circuits.

(14) The display apparatus described in any one of (11) to (13), wherein, the plurality of signal processing circuits further includes a display stop control unit obtaining a display stop instruction signal on the basis of an input latch signal when the display stop instruction signal is supplied and outputting the obtained display stop instruction signal to the write control unit and the read control unit,

wherein the write control unit stops storing the input image signal in the memory during a display stop period on the basis of the display stop instruction signal, and

the read control unit reads the image signal that corresponds to the frame identification information, which has been read before the display stop, during the display stop period on the basis of the display stop instruction signal.

In the signal processing circuit, the signal processing method, and the display apparatus according to the embodiments of the present disclosure, the write control signal that is in synchronization with the input image signal and the frame identification information are generated, and the input image signal is stored in the memory so that it corresponds to the frame identification information on the basis of the write control signal. Further, the read control signal is generated through obtaining the vertical synchronization signal supplied from outside based on the timing signal of the output horizontal frequency, and the image signal that corresponds to the frame identification information is read from the memory on the basis of the read control signal and the frame identification information supplied from outside. Through this, in the case of supplying the synchronization signal supplied from outside to the plurality of signal processing circuits, the phase difference between the image signals output from the signal processing circuit becomes smaller, and thus it is possible to make the phases of the image signals output from the signal processing circuits coincide with each other using line buffers. Accordingly, high-resolution image display can be performed with low delay, reduction in circuit size, low power consumption, and a small outlay. The present disclosure is appropriate to a display apparatus or the like that performs high-precision image display using image signals having various frame rates.

The present disclosure contains subject matter related to that disclosed in Japanese Priority Patent Application JP 2011-074348 filed in the Japan Patent Office on Mar. 30, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing circuit comprising:
a memory storing an image signal;
a write control unit generating a write control signal in synchronization with the input image signal and frame identification information, and storing the input image signal in the memory so that the input image signal corresponds to the frame identification information on the basis of the write control signal; and
a read control unit generating a read control signal through obtaining a vertical synchronization signal supplied from outside based on a timing signal of an output horizontal frequency, and reading an image signal that corresponds to the frame identification information from the memory on the basis of the read control signal and the frame identification information supplied from outside.

2. The signal processing circuit according to claim 1, wherein in the case of performing image display simultaneously using a plurality of signal processing circuits, the read control unit generates the read control signal and reads the image signal that corresponds to the frame identification information from the memory on the basis of the read control signal and the frame identification information.

3. The signal processing circuit according to claim 1, wherein the read control unit detects a phase difference between a vertical synchronization signal generated on the basis of the timing signal of the output horizontal frequency and the vertical synchronization signal supplied from outside and a phase difference between the timing signal of the output horizontal frequency and a horizontal synchronization signal supplied from outside, adjusts phases of the timing signal of the output horizontal frequency and the vertical synchronization signal that is generated on the basis of the timing signal so that the phase differences are less than a predetermined value, and generates the read control signal using the signal after the adjustment.

4. The signal processing circuit according to claim 1, further comprising a skew compensation unit delaying a synchronization signal supplied from outside so that the image signal that corresponds to the frame identification information can be read from the memory on the basis of the read control signal and the frame identification information even if the input image signal and an input image signal input to another signal processing circuit produce skews.

5. The signal processing circuit according to claim 1, further comprising a display stop control unit obtaining a display stop instruction signal on the basis of an input latch signal when the display stop instruction signal is supplied and outputting the obtained display stop instruction signal to the write control unit and the read control unit,
wherein the write control unit stops storing the input image signal in the memory during a display stop period on the basis of the display stop instruction signal, and
the read control unit reads the image signal that corresponds to the frame identification information, which has been read before the display stop, during the display stop period on the basis of the display stop instruction signal.

6. The signal processing circuit according to claim 5, wherein the display stop control unit obtains the display stop instruction signal on the basis of the input latch signal in the unit of a frame or in the unit of multiple frames.

7. The signal processing circuit according to claim 5, wherein the read control unit reads the image signal that corresponds to the frame identification information from the memory on the basis of the frame identification information supplied from outside and outputs the read image signal to outside as a captured image signal.

8. The signal processing circuit according to claim 5, wherein the write, control unit stores a replacement image signal in the memory to correspond to the frame identification information on the basis of the frame identification information supplied from outside.

9. The signal processing circuit according to claim 8, wherein the read control unit reads the replacement image signal stored in the memory to correspond to the frame identification information on the basis of the frame identification information supplied from outside.

10. The signal processing circuit according to claim 5, wherein the display stop control unit obtains the display stop instruction signal on the basis of the input latch signal in the unit of a frame or in the unit of multiple frames.

11. The signal processing circuit according to claim 1, wherein the memory stores the image signal that is used for signal processing.

12. A signal processing method comprising:
generating a write control signal in synchronization with an input image signal and frame identification information, and storing the input image signal in the memory so that the input image signal corresponds to the frame identification information on the basis of the write control signal; and
generating a read control signal through obtaining a vertical synchronization signal supplied from outside based on a timing signal of an output horizontal frequency, and reading an image signal that corresponds to the frame identification information from the memory on the basis of the read control signal and the frame identification information supplied from outside.

13. A display apparatus comprising:
signal processing circuits for a plurality of display areas that constitute one screen, which process image signals on the corresponding display areas, respectively,
wherein each of the signal processing circuits includes
a memory storing an image signal,
a write control unit generating a write control signal in synchronization with the input image signal and frame identification information, and storing the input image signal in the memory so that the input image signal corresponds to the frame identification information on the basis of the write control signal, and
a read control unit generating a read control signal through obtaining a vertical synchronization signal supplied from outside commonly to the respective signal processing circuits based on a timing signal of an output horizontal frequency, and reading an image signal that corresponds to the frame identification information from the memory on the basis of the read control signal and the frame identification information supplied from outside commonly to the respective signal processing circuits.

14. The display apparatus according to claim 13, further comprising an oscillation unit generating a reference frequency signal,
wherein the oscillation unit supplies the generated reference frequency signal to the respective signal processing circuits, and
the read control unit of the signal processing circuit detects a phase difference between a vertical synchronization signal generated on the basis of the timing signal of the output horizontal frequency and the vertical synchronization signal supplied from outside and a phase difference between the timing signal of the output horizontal frequency and a horizontal synchronization signal supplied from outside, adjusts phases of the timing signal of the output horizontal frequency and the vertical synchronization signal that is generated on the basis of the timing signal so that the phase differences are less than a predetermined value, and generates the read control signal using the signal after the adjustment.

15. The display apparatus according to claim 13, wherein the plurality of signal processing circuits comprise a skew compensation unit delaying a synchronization signal supplied from outside so that the image signal that corresponds to the frame identification information can be read from the memory on the basis of the read control signal and the frame identification information even if the input image signals which are input to the plurality of signal processing circuits produce skews between the signal processing circuits.

16. The display apparatus according to claim 13, wherein the plurality of signal processing circuits further comprise a display stop control unit obtaining a display stop instruction signal on the basis of an input latch signal when the display stop instruction signal is supplied and outputting the obtained display stop instruction signal to the write control unit and the read control unit,
wherein the write control unit stops storing the input image signal in the memory during a display stop period on the basis of the display stop instruction signal, and
the read control unit reads the image signal that corresponds to the frame identification information, which has been read before the display stop, during the display stop period on the basis of the display stop instruction signal.
